(19) United States
(12) Patent Application Publication
(10) Pub. No.: US 2026/0296357 A1
(43) Pub. Date: Oct. 1, 2026

(54) AIRBAG DEVICE

(71) Applicant: TOYODA GOSEI CO., LTD., Kiyosu-shi (JP)

(72) Inventors: Yuki Mori, Kiyosu-shi (JP); Shota Watanabe, Kiyosu-shi (JP); Hiroki Yoshida, Kiyosu-shi (JP)

(21) Appl. No.: 19/544,151

(22) Filed: Feb. 19, 2026

(30) Foreign Application Priority Data
Mar. 31, 2025 (JP) 2025-057660
Oct. 23, 2025 (JP) 2025-178660

(51) Int. Cl. B60R 21/233; B60R 21/206; B60R 21/231

(52) U.S. Cl. CPC B60R 21/233; B60R 21/206; B60R 2021/23169

(57) ABSTRACT

An airbag device is disposed in front of an occupant seated on a seat, and includes an airbag that is folded and is stored in a storage portion. The airbag is configured to inflate so as to cover a front portion from knees to an upper body of the occupant, and includes an upper body protection portion configured to protect the upper body and a knee protection portion configured to protect the knees. Each of the upper body protection portion and the knee protection portion is formed in a shape of a separate bag, is connected to a separate inflator, is configured to allow an inflation gas to flow into the upper body protection portion or the knee protection portion, and is folded and is stored in the storage portion.

### CROSS REFERENCE TO RELATED APPLICATION

The present application claims priority from Japanese Patent Application No. 2025-057660 of Yoshida et al., filed on Mar. 31, 2025, and Japanese Patent Application No. 2025-178660 of Mori et al., filed on Oct. 23, 2025, the entire disclosures of which are incorporated herein by reference.

### BACKGROUND

### 1. Technical Field

The present disclosure relates to an airbag device including an airbag that is disposed in front of an occupant seated on a seat and is folded and stored in a storage portion.

### 2. Description of Related Art

In the related art, there has been an airbag device having a configuration described in JP 2024-24685 A. The airbag device in the related art is an airbag device for a passenger seat that is disposed in front of the passenger seat, and has a configuration in which an airbag protrudes from a storage portion disposed on a lower side of an instrument panel in front of the passenger seat and the inflated airbag protects an occupant seated on the passenger seat from the knees to the upper body.

However, in the airbag device in the related art, the airbag has a configuration in which a knee protection region for receiving the knees and an upper body protection region for receiving the upper body are integrally disposed. For this reason, for example, when the completely inflated airbag receives the knees before the upper body, the inflation gas may move from the knee protection region toward the upper body protection region due to a contact with the knees. In such a case, an internal pressure necessary for protecting the knees may not be secured, and as a result, there is a risk that the knees may not be properly protected.

### SUMMARY

According to the present disclosure, there is provided an airbag device disposed in front of an occupant seated on a seat, the airbag device including: an airbag that is folded and is stored in a storage portion and inflates so as to cover a front portion from knees to an upper body of the occupant, wherein the airbag includes an upper body protection portion configured to protect the upper body and a knee protection portion configured to protect the knees, and each of the upper body protection portion and the knee protection portion is formed in a shape of a separate bag, is connected to a separate inflator, is configured to allow an inflation gas to flow into the upper body protection portion or the knee protection portion, and is folded and is stored in the storage portion.

### BRIEF DESCRIPTION OF THE DRAWINGS

FIG. 1 is a schematic longitudinal sectional view of an airbag device for a passenger seat according to an embodiment of the present disclosure in a state of being mounted on a vehicle;

FIG. 2 is a schematic enlarged longitudinal sectional view of the airbag device for a passenger seat according to the embodiment;

FIG. 3 is a schematic enlarged transverse sectional view of the airbag device for a passenger seat according to the embodiment;

FIG. 4 is a left side view illustrating a state where an airbag used in the airbag device for a passenger seat according to the embodiment is inflated alone;

FIG. 5 is a plan view of the airbag of FIG. 4 when viewed from above;

FIG. 6 is a rear view of the airbag of FIG. 4 when viewed from a rear side;

FIG. 7 is a schematic longitudinal sectional view of the airbag of FIG. 4 taken along a front-rear direction;

FIG. 8 is a schematic partial longitudinal sectional view illustrating a portion of a communication hole in the airbag of FIG. 4 taken along a left-right direction;

FIG. 9 is a schematic partial transverse sectional view illustrating a portion of the communication hole in the airbag of FIG. 4;

FIG. 10 is a schematic partial enlarged longitudinal sectional view illustrating a portion of a knee protection portion in the airbag in FIG. 4;

FIG. 11 is a schematic partial transverse sectional view illustrating a portion of a gas passage portion of the knee protection portion in the airbag in FIG. 4;

FIG. 12 is a schematic partial longitudinal sectional view illustrating a portion of the gas passage portion of the knee protection portion in the airbag in FIG. 4;

FIG. 13 is a partial sectional view illustrating a portion of a lower regulating tether that connects a left portion of the knee protection portion and a lower inflatable portion in the airbag of FIG. 4;

FIG. 14 is a plan view of the airbag of FIG. 4 in a state where base materials that form an upper inflatable portion of an upper body protection portion and base materials that form an internal tether are disposed;

FIG. 15 is a plan view of the airbag of FIG. 4 in a state where base materials that form a lower inflatable portion of the upper body protection portion, a base material that forms a gas passage portion of a knee protection portion, and base materials that form a straightening cloth are disposed;

FIG. 16 is a plan view of the airbag of FIG. 4 in a state where base materials that form a protection main body portion of the knee protection portion is disposed;

FIG. 17A is a front view of a pre-folded bag obtained by pre-folding the airbag of FIG. 4, and FIG. 17B is a rear view of the pre-folded bag;

FIG. 18A to FIG. 18D are schematic views illustrating a folding step of folding the airbag of FIG. 4;

FIG. 19 is a schematic longitudinal sectional view illustrating a completely inflated state of the airbag in the airbag device for a passenger seat according to the embodiment;

FIG. 20 is a schematic partial enlarged longitudinal sectional view illustrating a portion of the knee protection portion when the airbag is completely inflated in the airbag device for a passenger seat according to the embodiment;

FIG. 21 is a schematic transverse sectional view illustrating a portion of a case when inflation of the airbag is completed in the airbag device for a passenger seat according to the embodiment;

FIG. 22 is a plan view of a state where an airbag according to another embodiment of the present disclosure is inflated alone when viewed from above;

FIG. 23 is a schematic partial enlarged longitudinal sectional view illustrating portions corresponding to a lower inflatable portion of the upper body protection portion and a knee protection portion in the airbag of FIG. 22 taken along the front-rear direction;

FIG. 24 is a partial sectional view illustrating a front portion of a lower regulating tether that connects a left portion of the knee protection portion and a lower inflatable portion in the airbag of FIG. 22;

FIG. 25 is a partial sectional view illustrating a rear portion of a lower regulating tether that connects a left portion of the knee protection portion and a lower inflatable portion in the airbag of FIG. 22;

FIG. 26 is a plan view of the airbag of FIG. 22 in a state where base materials that form an upper inflatable portion of an upper body protection portion and base materials that form an internal tether are disposed;

FIG. 27 is a plan view of the airbag of FIG. 22 in a state where base materials that form a lower inflatable portion of the upper body protection portion and a base material that forms a gas passage portion of a knee protection portion are disposed; and

FIG. 28 is a plan view of the airbag of FIG. 22 in a state where base materials that form a protection main body portion of the knee protection portion is disposed.

### DESCRIPTION OF THE PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

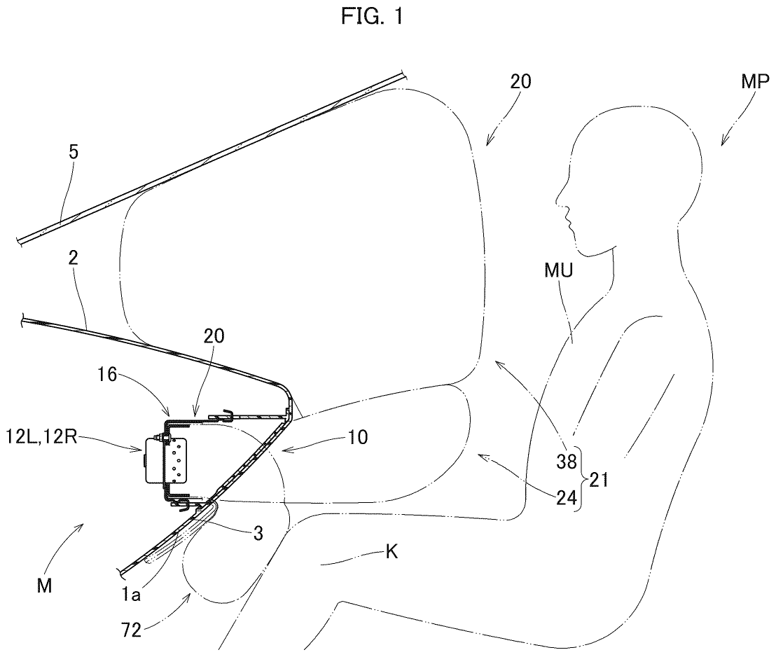

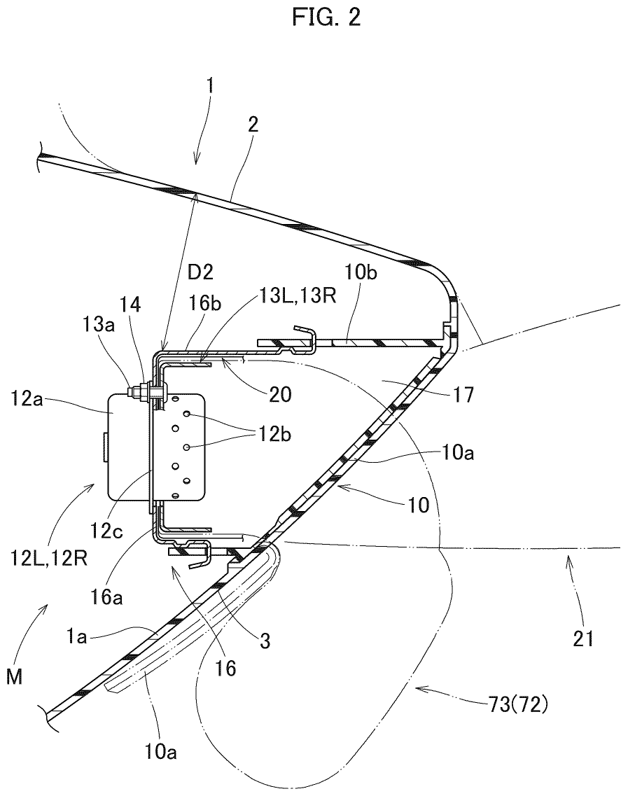

Hereinafter, an embodiment of the present disclosure will be described with reference to the drawings. In the embodiment, as an airbag device M, an airbag device for a passenger seat will be described as an example. As illustrated in FIG. 1 and FIG. 2, an airbag device for a passenger seat (hereinafter, abbreviated as an “airbag device”) M according to the embodiment is disposed on a rear surface 3 side which is a lower portion 1a side of an instrument panel 1. In the embodiment, front-rear, up-down, and left-right directions coincide with front-rear, up-down, and left-right directions of a vehicle unless otherwise specified.

As illustrated in FIG. 1 to FIG. 3, the airbag device M includes a case 16 that is a storage portion disposed at the lower portion 1a of the instrument panel 1, an airbag 20 that is folded and stored in the case 16, two inflators 12L and 12R that supply an inflation gas to the airbag 20, two retainers 13L and 13R for attaching the airbag 20 and the inflators 12L and 12R to the case 16, and an airbag cover 10 that covers the folded airbag 20.

The airbag cover 10 is formed so as to be continuous with the instrument panel 1, and is made of synthetic resin. The airbag cover 10 includes one door portion 10a that opens when the airbag 20 is deployed and inflated. In the embodiment, the door portion 10a is formed to be pushed by the airbag 20 and open downward. In addition, a connection wall portion 10b connected to the case 16 is formed around the door portion 10a of the airbag cover 10 so as to protrude forward.

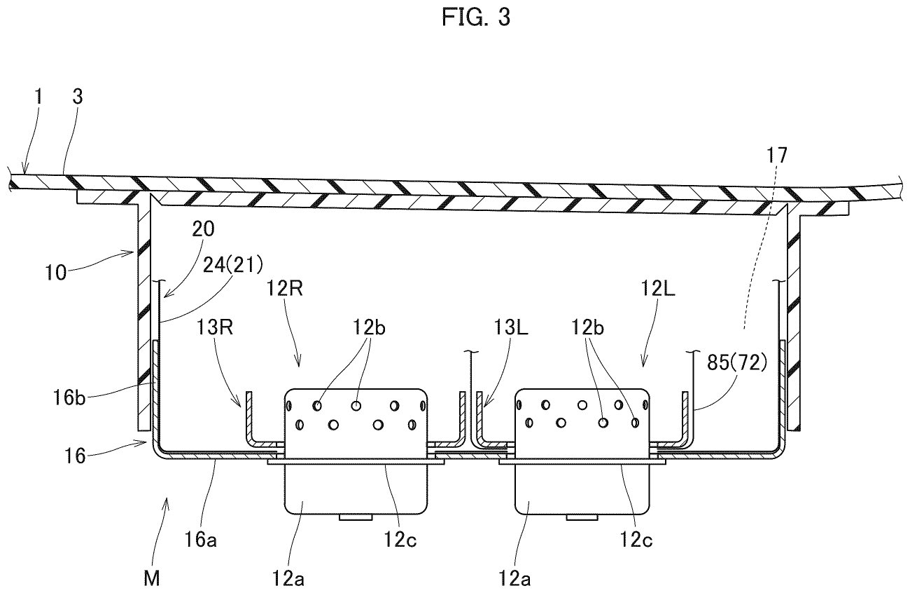

In the embodiment, the two inflators 12L and 12R are attached to a bottom wall portion 16a (to be described later) of the case 16 so as to be disposed side by side in the left-right direction. In the embodiment, the inflator 12L disposed on the left side supplies an inflation gas G2 to a knee protection portion 72 (to be described later) of the airbag 20. The inflator 12R disposed on the right side supplies an inflation gas G1 to an upper body protection portion 21 (to be described later) of the airbag 20 (refer to FIG. 3 and FIG. 19 to FIG. 21). The inflators 12L and 12R have the same configuration except for different outputs. The inflator 12R for the upper body protection portion 21 having a large volume is set to have a larger output than the inflator 12L for the knee protection portion 72. Each of the inflators 12L and 12R includes a main body portion 12a that has a substantially columnar shape and has a plurality of gas discharge ports 12b, and a flange portion 12c for attaching the inflator 12L or 12R to the case 16 (refer to FIG. 3). In the airbag device M according to the embodiment, each of the inflators 12L and 12R is attached to a front end side (bottom wall portion 16a) of the case 16 such that the axial direction of the main body portion 12a is aligned with the front-rear direction. Each of the inflators 12L and 12R is electrically connected to an airbag operation circuit (not illustrated) by a lead wire (not illustrated). In the embodiment, the inflators 12L and 12R are set to operate at substantially the same time.

The case 16 that is a storage portion has a substantially rectangular parallelepiped shape that is flat and extends in the left-right direction, and has a rectangular opening on the rear end side. As illustrated in FIG. 2 and FIG. 3, the case 16 includes a bottom wall portion 16a having a substantially rectangular shape and a circumferential wall portion 16b extending rearward from an outer circumferential edge of the bottom wall portion 16a. The bottom wall portion 16a is a portion to which each of the inflators 12L and 12R is inserted and attached from the front. The circumferential wall portion 16b is a portion that engages the connection wall portion 10b of the airbag cover 10. The case 16 is disposed on the lower portion 1a side of the instrument panel 1 (a position separated from an upper surface 2 of the instrument panel 1). Specifically, the case 16 is disposed at a position on a front upper side of the knee K of an occupant MP seated on a passenger seat such that the axial direction of the case is aligned with the front-rear direction (horizontal direction) (refer to FIG. 1). The opening provided on the rear end side of the case 16 forms a protruding opening 17 through which the airbag 20 can protrude rearward when the airbag 20 inflates by allowing the inflation gas to flow therein. In the embodiment, the airbag 20 and the inflators 12L and 12R are attached to the bottom wall portion 16a of the case 16 as described below. The bolts 13a of the retainers 13L and 13R disposed in the airbag 20 serve as attachment means. Each of these bolts 13a penetrates a circumferential edge of each of inflow openings 28L and 28R (to be described later) of the airbag 20, the bottom wall portion 16a of the case 16, and the flange portion 12c of each of the inflators 12L and 12R, and is fixed to a nut 14. The case 16 is connected to a body side of the vehicle by using a bracket (not illustrated).

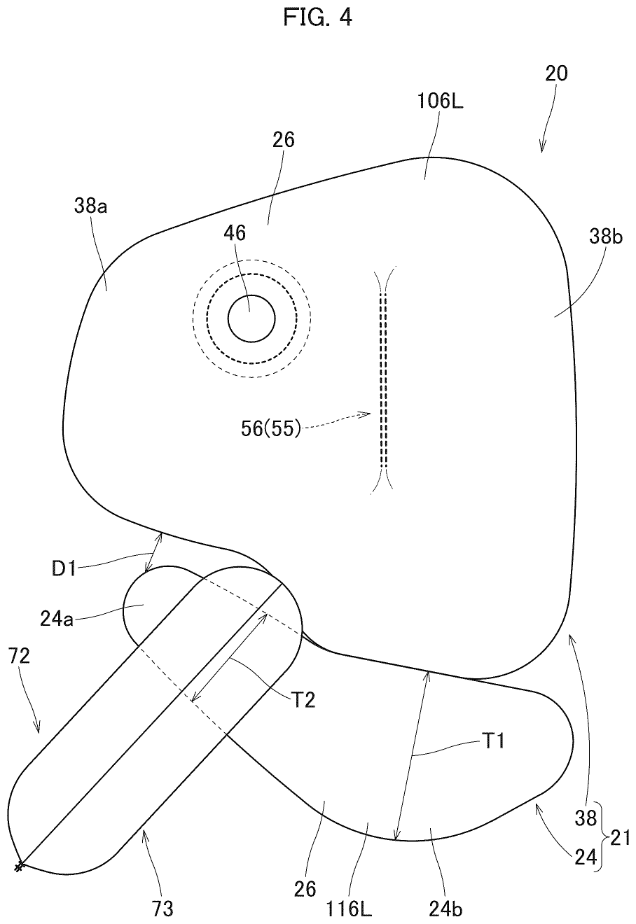

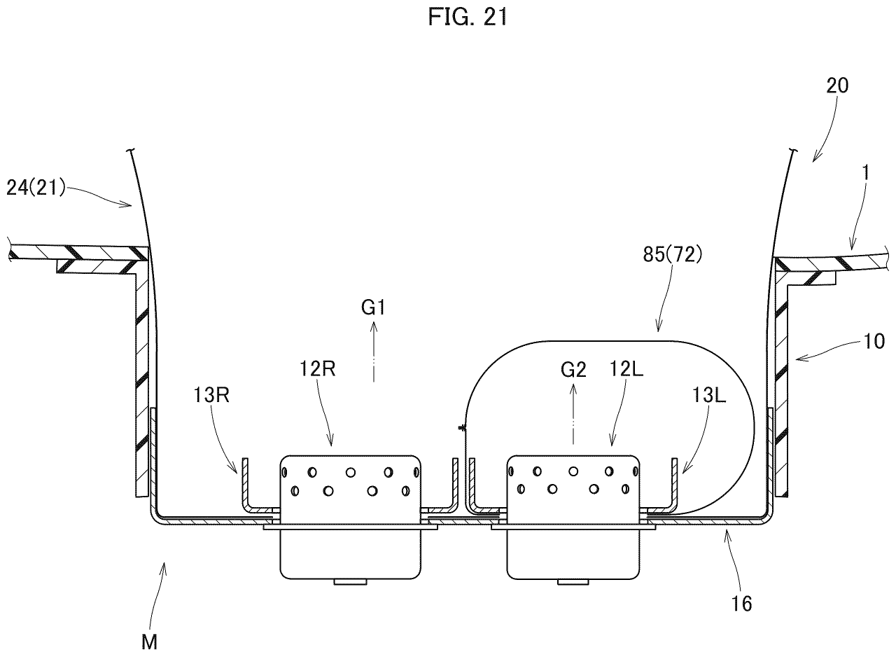

The airbag 20 is formed of a flexible sheet body. As illustrated in FIG. 4 to FIG. 7, the airbag 20 includes an upper body protection portion 21 and a knee protection portion 72 each of which is formed in a shape of a separate bag. The upper body protection portion 21 is connected to the right inflator 12R, and is formed to allow the inflation gas G1 discharged from the inflator 12R to flow into the inside thereof. The knee protection portion 72 is connected to the left inflator 12L, and is formed to allow the inflation gas G2 discharged from the inflator 12L to flow into the inside thereof (refer to FIG. 21). The upper body protection portion 21 and the knee protection portion 72 are completely divided, and the inflation gas flowing into the upper body protection portion 21 and the knee protection portion 72 cannot move between the upper body protection portion 21 and the knee protection portion 72. In addition, a lower inflatable portion 24 (to be described later) of the upper body protection portion 21 and the knee protection portion 72 are connected to each other by lower regulating tethers 97L and 97R.

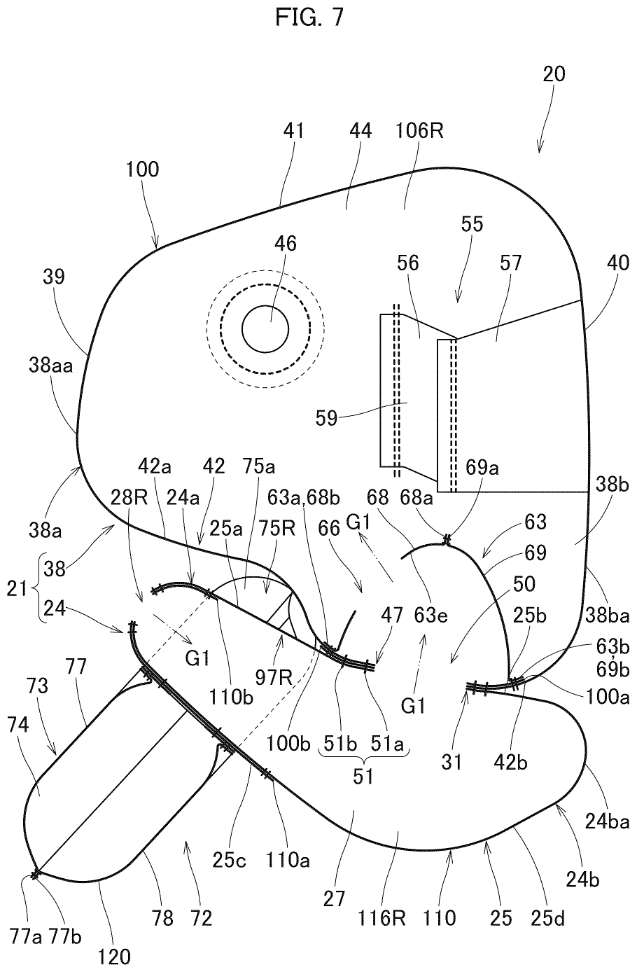

The upper body protection portion 21 is disposed in front of the upper body MU of the occupant MP when inflation is completed. As illustrated in FIG. 4 to FIG. 7, the upper body protection portion 21 includes an upper inflatable portion 38 and a lower inflatable portion 24 each of which is formed in a shape of a separate bag. The upper inflatable portion 38 and the lower inflatable portion 24 communicate with each other via a communication hole 50, and are connected to each other by being coupled at a portion of a circumferential edge of the communication hole 50 (refer to FIG. 7 to FIG. 9).

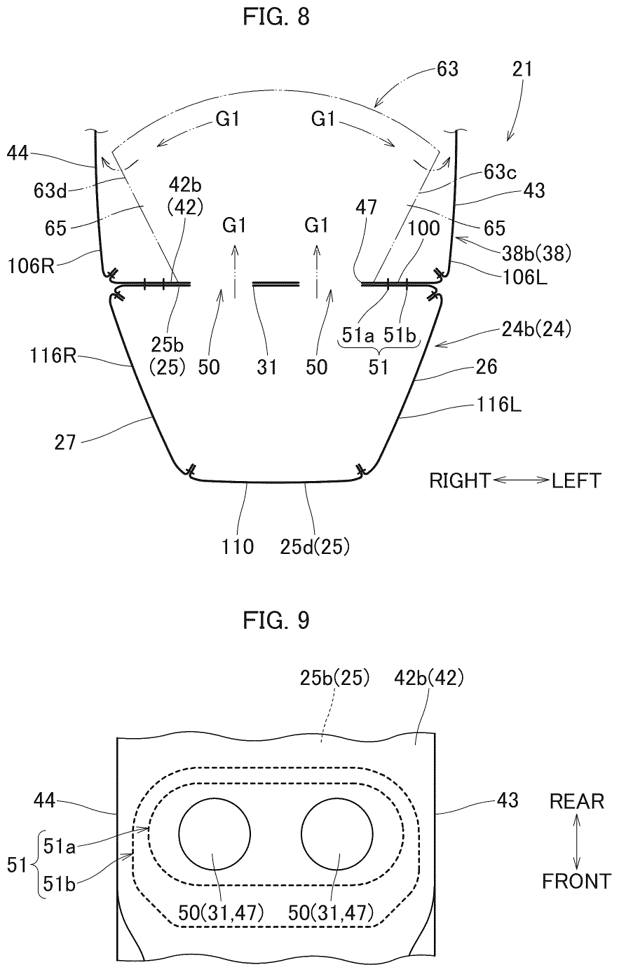

The lower inflatable portion 24 is a portion that is connected to the inflator 12R and inflates so as to protrude rearward from the case 16. The lower inflatable portion 24 has a substantially rectangular plate shape when inflation is completed. The lower inflatable portion 24 includes a left wall portion 26 and a right wall portion 27 that are disposed so as to face each other in the left-right direction when inflation is completed, and a circumferential wall portion 25 that connects the left wall portion 26 and the right wall portion 27 to form a region in the front-rear direction and the up-down direction when inflation is completed (refer to FIG. 7 and FIG. 8). As described above, the lower inflatable portion 24 is connected to the knee protection portion 72 by the lower regulating tethers 97L and 97R. Specifically, a left edge side and a right edge side of the lower inflatable portion 24 are respectively connected to a protection main body portion 73 (to be described later) of the knee protection portion 72, more specifically, the peripheries of upper ends 75a of a left portion 75L and a right portion 75R (to be described later) of the protection main body portion 73 by the lower regulating tethers 97L and 97R.

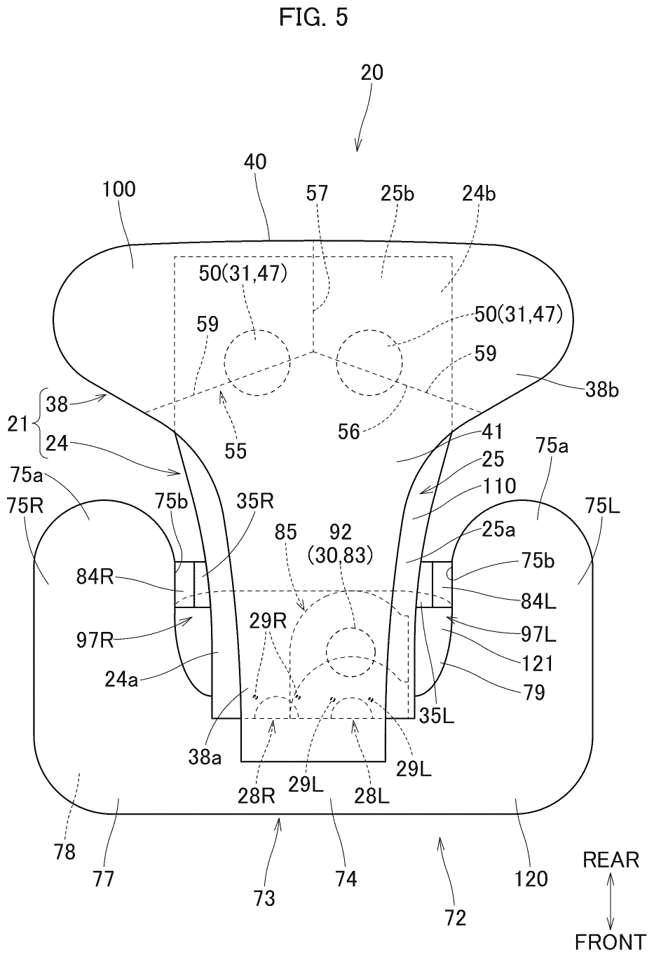

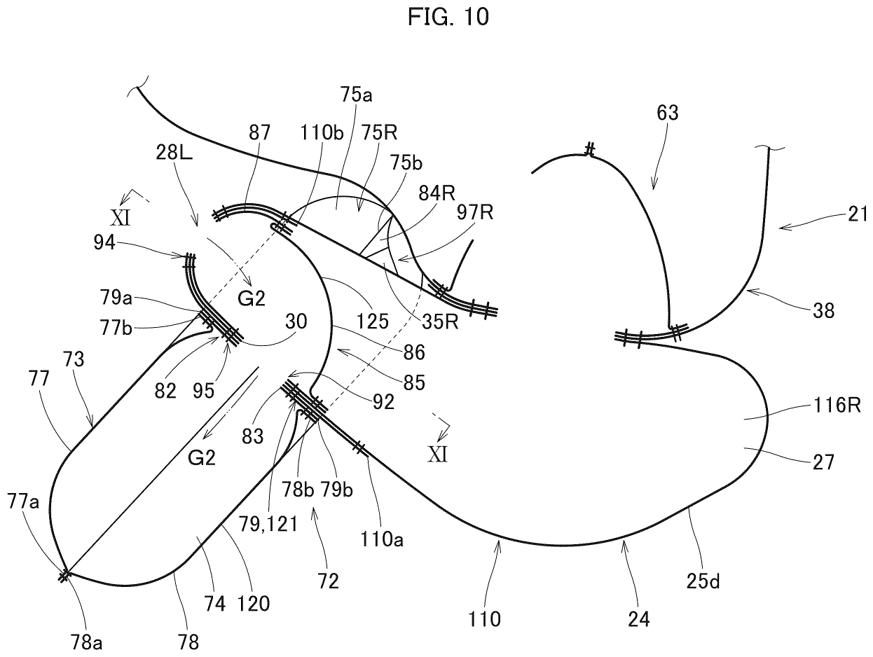

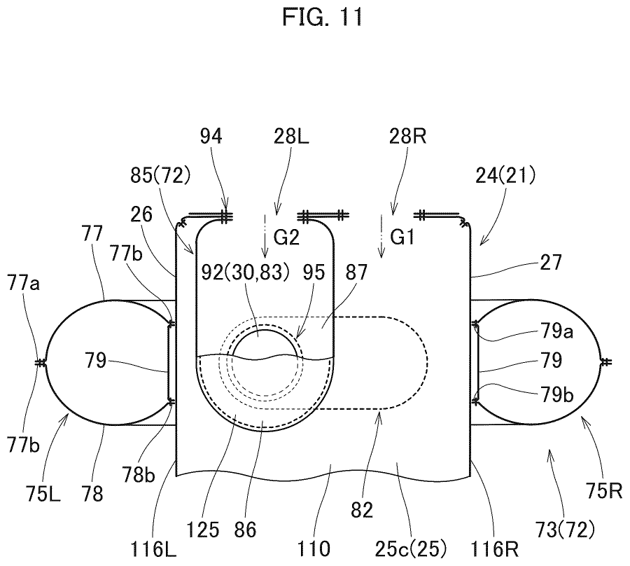

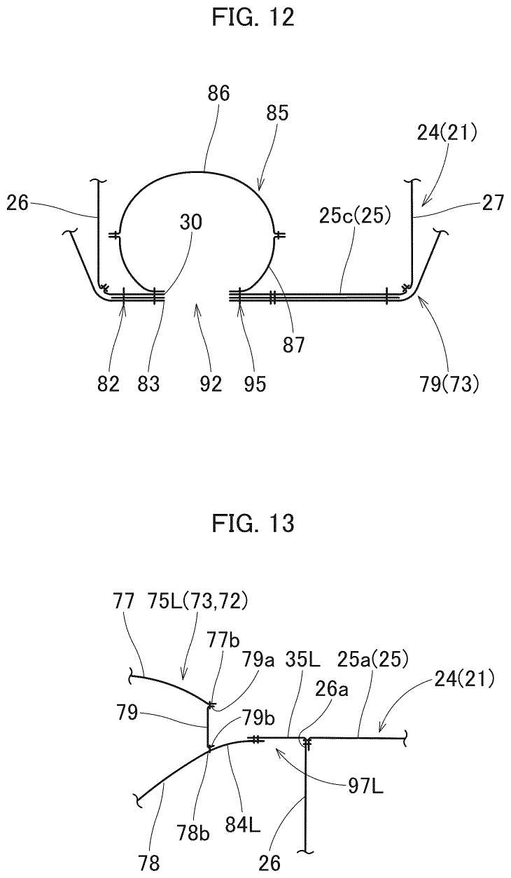

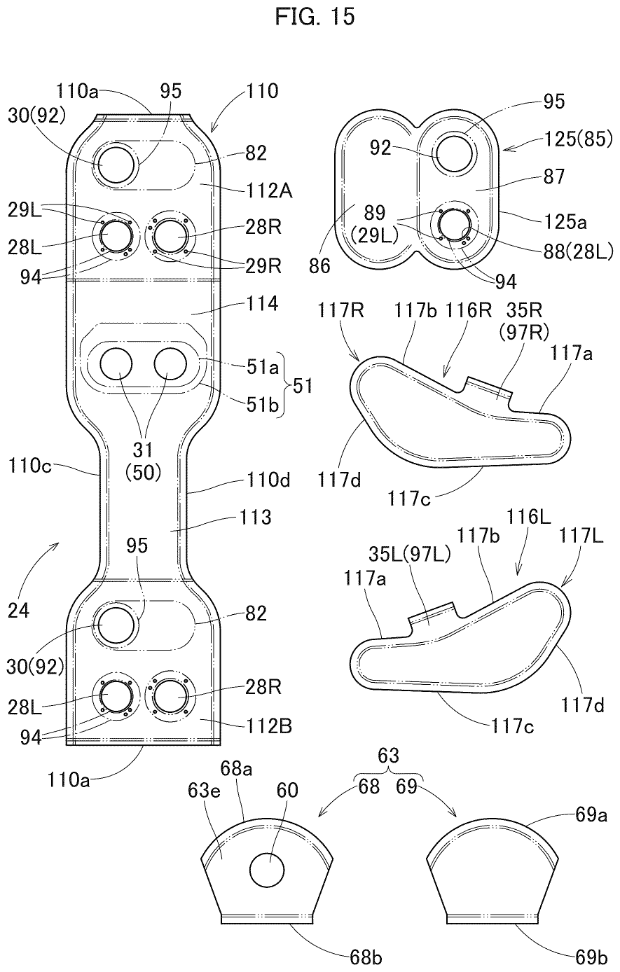

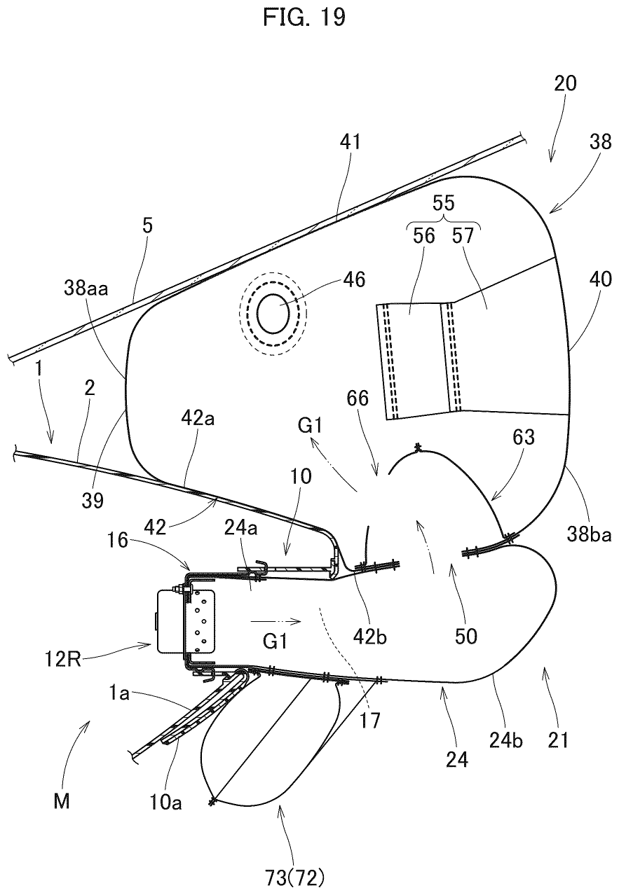

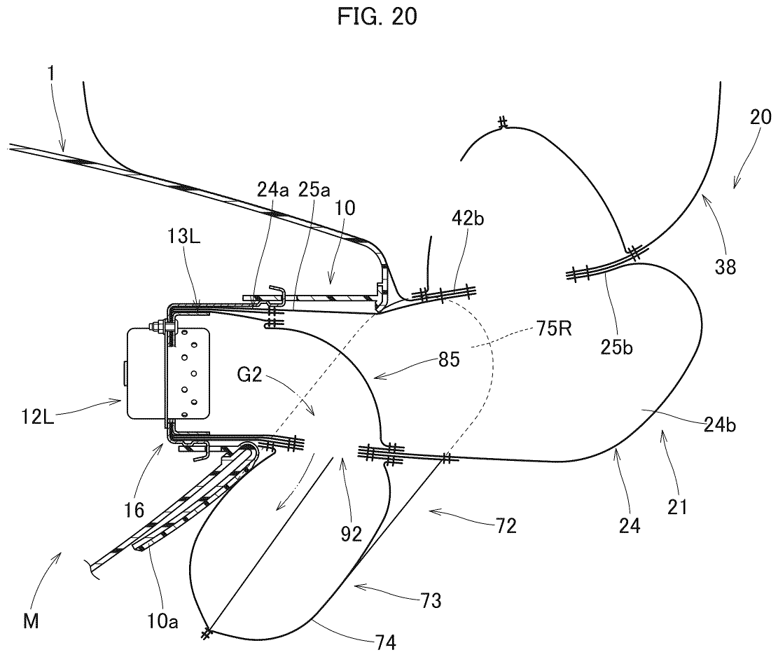

On the front end side of the circumferential wall portion 25, two inflow openings 28L and 28R of which the circumferential edges are attached to the bottom wall portion 16a of the case 16 are disposed side by side in the left-right direction (refer to FIG. 5, FIG. 11, and FIG. 15). Each of the inflow openings 28L and 28R is opened in a circular shape. These inflow openings 28L and 28R are for connecting the inflators 12L and 12R. A plurality of (in the embodiment, 4) attachment holes 29L and 29R are formed at the circumferential edges of the inflow openings 28L and 28R (refer to FIG. 5 and FIG. 15). The attachment holes 29L and 29R are formed to attach the circumferential edges of the inflow openings 28L and 28R to the bottom wall portion 16a of the case 16 by inserting bolts 13a of the retainers 13L and 13R into the attachment holes 29L and 29R. In the embodiment, the right inflow opening 28R is for connecting the inflator 12R. The inflation gas G1 discharged from the inflator 12R flows into the lower inflatable portion 24 through the inflow opening 28R (refer to FIG. 7, FIG. 19, and FIG. 21). The left inflow opening 28L is for connecting the inflator 12L. In the lower inflatable portion 24, a gas passage portion 85 (to be described later) of the knee protection portion 72 is disposed so as to cover the entire outer circumferential side of the inflow opening 28L (refer to FIG. 10, FIG. 12, FIG. 20, and FIG. 21). Then, as illustrated in FIG. 10, FIG. 20, and FIG. 21, the inflation gas G2 discharged from the inflator 12L flows into the knee protection portion 72 through the inflow opening 28L and the gas passage portion 85. That is, in the airbag 20 according to the embodiment, a front end side of the lower inflatable portion 24 is connected to the case 16 side by the two inflow openings 28L and 28R, with a wide width in the left-right direction. However, the inflation gas G1 flows into the lower inflatable portion 24 only from the front right end region.

In the circumferential wall portion 25, an opening 30 is formed to be opened in a circular shape on the left side at a position located in front of the center of a lower portion in the front-rear direction that forms a lower surface side of the lower inflatable portion 24 (a position adjacent to and behind the inflow opening 28L in a region of a front lower portion 25c) (refer to FIG. 10 to FIG. 12 and FIG. 15). The opening 30 corresponds to an outflow hole 92 formed in the gas passage portion 85 that allows the inflation gas to flow out to the protection main body portion 73 (to be described later) of the knee protection portion 72. The periphery of the opening 30 is also covered with the gas passage portion 85 over the entire circumference on the outer circumferential side, together with the inflow opening 28L. In addition, in the circumferential wall portion 25, an opening 31 which forms the communication hole 50 is formed at a position slightly rearward of the center of an upper portion in the front-rear direction that forms an upper surface side of the lower inflatable portion 24 (a rear upper portion 25b which is an upper surface side of a rear region 24b (to be described later)) (refer to FIG. 5, FIG. 7 to FIG. 9, and FIG. 15). In the embodiment, two openings 31 are disposed side by side in the left-right direction while being opened in a circular shape. Further, connection pieces 35L and 35R that form the lower regulating tethers 97L and 97R are formed on an upper left edge side and an upper right edge side of the lower inflatable portion 24 (sides toward upper edges 26a and 27a of the left wall portion 26 and the right wall portion 27). Each of the connection pieces 35L and 35R is formed in a band shape substantially along the front-rear direction at a position slightly forward of each of the centers of the upper edges of the left wall portion 26 and the right wall portion 27 in the front-rear direction (refer to FIG. 5 and FIG. 15). In the embodiment, the connection pieces 35L and 35R are formed so as to protrude from the periphery of a boundary portion between a front upper portion 117a and a rear upper portion 117b of outer circumferential edges 117L and 117R of lower wall panels 116L and 116R (to be described later) that form the left wall portion 26 and the right wall portion 27 (refer to FIG. 15).

The lower inflatable portion 24 includes a front region 24a that is disposed in the case 16 when inflation is completed, and a rear region 24b that is disposed behind the front region 24a and below the upper inflatable portion 38 when inflation is completed (refer to FIG. 19 and FIG. 20). The inflow openings 28L and 28R and the attachment holes 29L and 29R are disposed on a front end side of the front region 24a. The opening 30 that forms the outflow hole 92 is disposed on a lower surface side of the front region 24a. The opening 31 that forms the communication hole 50 is disposed on an upper surface side of the rear region 24b (refer to FIG. 5 and FIG. 7). In the airbag 20 according to the embodiment, when the lower inflatable portion 24 in a completely inflated state is viewed from the left-right direction when being mounted on the vehicle, as illustrated in FIG. 19 and FIG. 20, the front region 24a is disposed along the front-rear direction (horizontal direction), and the rear region 24b is disposed so as to be inclined rearward and upward with respect to the front-rear direction (horizontal direction). When inflation of the front region 24a alone is completed, a width dimension (a width dimension in the left-right direction) is substantially constant over the entire region in the front-rear direction. In addition, a thickness dimension of the front region 24a is also substantially constant over the entire region in the front-rear direction (refer to FIG. 4, FIG. 5, and FIG. 7). A thickness dimension T1 of the rear region 24b when inflation is completed (a thickness dimension of the outer shape when inflation is completed as viewed from the left-right direction) is set to be thicker than a thickness dimension T2 of the front region 24a when inflation is completed (refer to FIG. 4). Further, in the rear region 24b, an upper surface (a rear upper portion 25b which is a region where the opening 31 forming the communication hole 50 is disposed in the circumferential wall portion 25) when inflation is completed is also inclined rearward and upward with respect to the horizontal direction when viewed from the left-right direction in a state where the airbag 20 is mounted on the vehicle and is completely inflated (refer to FIG. 20). A difference in thickness between the front region 24a and the rear region 24b and the rearward and upward inclination of the rear region 24b are caused by the outer shapes of a pair of left and right lower wall panels 116L and 116R (to be described later) (refer to FIG. 15) that form the left wall portion 26 and the right wall portion 27 of the lower inflatable portion 24.

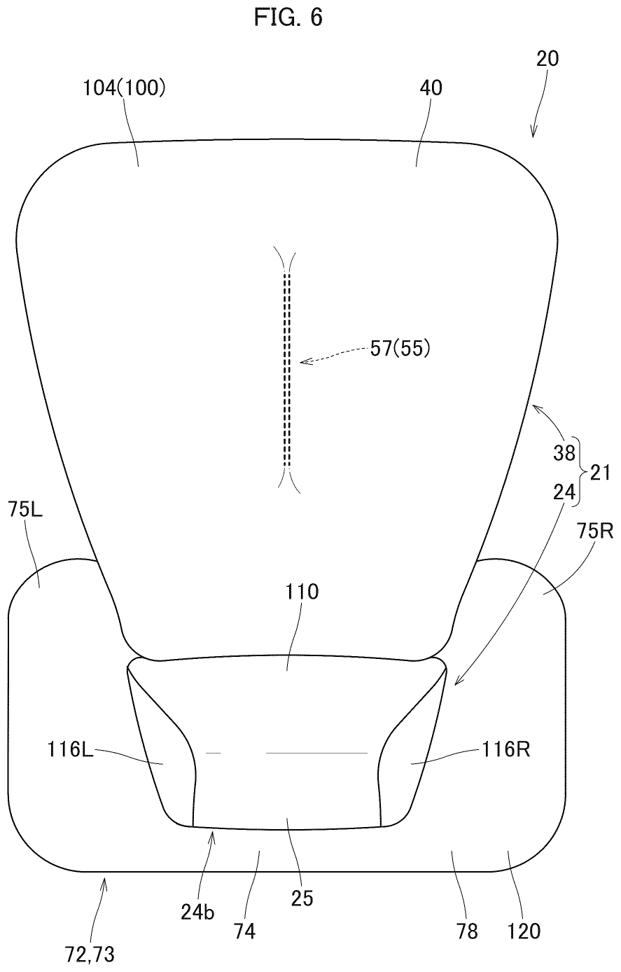

The rear upper portion 25b that forms the upper surface of the rear region 24b is disposed to be inclined rearward and upward with respect to the horizontal direction when viewed from the left-right direction in a state where the airbag 20 is mounted on the vehicle and is completely inflated (refer to FIG. 20). The rear region 24b is formed to support a rear lower end side of the upper inflatable portion 38 when inflation of the airbag 20 is completed. The width dimension of the upper surface side (the rear upper portion 25b) of the rear region 24b in the left-right direction substantially coincides with the width dimension of the rear lower surface (the rear portion 42b of the lower wall portion 42 (to be described later)) of the upper inflatable portion 38 in the left-right direction (refer to FIG. 6). Further, in the embodiment, as illustrated in FIG. 7, when inflation of the airbag 20 is completed, a rear end 24ba of the rear region 24b is disposed at a position substantially coinciding with a rear end 38ba of the upper inflatable portion 38 in the front-rear direction. Furthermore, a shape of the rear region 24b in an inflation completion state when viewed from the rear side is a substantially trapezoidal shape having a narrower width toward the lower side (refer to FIG. 6). In the upper body protection portion 21 of the airbag 20 according to the embodiment, a shape of the upper inflatable portion 38 in an inflation completion state when viewed from the rear side is also a shape having a narrower width toward the lower side. Then, in the shape in an inflation completion state when viewed from the rear side, a left edge and a right edge of the rear region 24b are continuous with an outline of the upper inflatable portion 38 (refer to FIG. 6).

The upper inflatable portion 38 having a bag shape communicates with the lower inflatable portion 24 via the communication hole 50. The upper inflatable portion 38 is a portion that protects the upper body MU of the occupant MP seated on the passenger seat. The upper inflatable portion 38 is disposed so as to close a space between the upper surface 2 of the instrument panel 1 and a front windshield 5 disposed above the instrument panel 1 when inflation is completed. A rear lower surface side of the upper inflatable portion 38 is supported by the lower inflatable portion 24 (refer to FIG. 19). As illustrated in FIG. 4 to FIG. 7, the upper inflatable portion 38 includes a front wall portion 39 and a rear wall portion 40 that face each other in the front-rear direction when inflation is completed, an upper wall portion 41 and a lower wall portion 42 that face each other in the up-down direction when inflation is completed, and a left wall portion 43 and a right wall portion 44 that face each other in the left-right direction when inflation is completed. In addition, in the upper inflatable portion 38 of the upper body protection portion 21 of the airbag 20 according to the embodiment, the rear region 38b (region on the rear wall portion 40 side) disposed on the occupant MP side when inflation of the airbag 20 is completed is wide in the left-right direction so as to accurately protect the upper body MU of the occupant MP. The front region 38a disposed on the front side is formed to have a narrow width in the left-right direction (refer to FIG. 5). In the case of the embodiment, as illustrated in FIG. 5, a width dimension of the front region 38a in the left-right direction when inflation is completed is set to be smaller than a width dimension of the front region 24a of the lower inflatable portion 24 in the left-right direction.

In the upper inflatable portion 38, the rear wall portion 40 is disposed substantially along the up-down direction in front of the upper body MU of the occupant MP seated on the passenger seat when the airbag 20 is completely inflated. That is, the rear wall portion 40 is a portion that receives and protects the upper body MU of the occupant MP moving forward. The width dimensions of the rear wall portion 40 in the up-down direction and the left-right direction are set to dimensions such that the rear wall portion 40 can receive and protect the upper body MU of the occupant MP. Specifically, the outer shape of the rear wall portion 40 when viewed from the rear side is a substantially inverted trapezoidal shape in which a width on the upper side is wide and a width on the lower end side is narrower toward the lower side in the left-right direction (refer to FIG. 6). The upper wall portion 41 is a portion that is disposed to be inclined forward and downward when the airbag 20 is completely inflated and is brought into contact with the front windshield 5. A front portion 42a of the lower wall portion 42 is a portion that is brought into contact with the upper surface 2 of the instrument panel 1 when inflation of the airbag 20 is completed (refer to FIG. 19). A rear portion 42b of the lower wall portion 42 is disposed so as to be located one step lower than the front portion 42a when inflation of the airbag 20 is completed. The rear portion 42b is a portion that is disposed in contact with the rear upper portion 25b of the circumferential wall portion 25 of the lower inflatable portion 24 (refer to FIG. 19). The front wall portion 39 is a portion that is disposed substantially along the up-down direction so as to connect the front end of the upper wall portion 41 and the front end of the front portion 42a of the lower wall portion 42. In the airbag 20 (the upper body protection portion 21) according to the embodiment, the front wall portion 39 (the front end 38aa of the upper inflatable portion 38 when inflation is completed) is located in front of the front end (the inflow openings 28L and 28R) of the lower inflatable portion 24. That is, when inflation of the airbag 20 is completed, as illustrated in FIG. 19, the front end 38aa of the upper inflatable portion 38 is located in front of the case 16. In the left wall portion 43 and the right wall portion 44, a vent hole 46 for discharging an excessive inflation gas flowing into the upper inflatable portion 38 is formed to be opened in a substantially circular shape. Each of the vent holes 46 is disposed at a position in the periphery of a front upper edge of each of the left wall portion 43 and the right wall portion 44 (a position in front of an internal tether 55 (to be described later) and in the front region 38a of the upper inflatable portion 38).

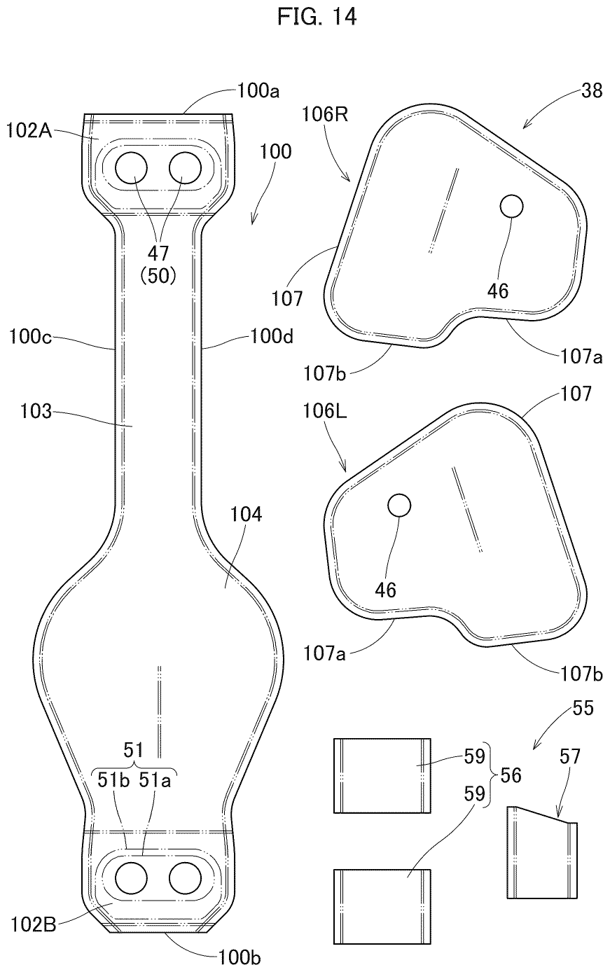

An opening 47 that forms the communication hole 50 is formed in the rear portion 42b (a region that is located on a lower surface side of the rear region 38b of the upper inflatable portion 38 and is supported by the lower inflatable portion 24 when inflation is completed) of the lower wall portion 42 (refer to FIG. 5, FIG. 7, FIG. 8, and FIG. 14). The opening 47 corresponds to the opening 31 that is formed in the rear upper portion 25b of the circumferential wall portion 25 of the lower inflatable portion 24. The two openings 47 are disposed side by side in the left-right direction while being opened in a circular shape. That is, in the upper body protection portion 21 of the airbag 20 according to the embodiment, two communication holes 50 for communicating the upper inflatable portion 38 and the lower inflatable portion 24 are provided side by side in the left-right direction. Specifically, the communication holes 50 are formed at two positions that are symmetrical in the left-right direction with respect to the center of the airbag 20 in the left-right direction in a state where the airbag 20 is inflated (refer to FIG. 5 and FIG. 8).

The upper inflatable portion 38 and the lower inflatable portion 24 are connected to each other by sewing the rear portion 42b of the lower wall portion 42 and the rear upper portion 25b of the circumferential wall portion 25 using a suture at the circumferential edge of the communication hole 50 (the circumferential edge of each of the openings 31 and 47). In the embodiment, as illustrated in FIG. 9, a sewn portion 51 connecting the upper inflatable portion 38 and the lower inflatable portion 24 (the rear portion 42b and the rear upper portion 25b) is doubly formed so as to surround the two communication holes 50 over the entire circumference. Specifically, in the sewn portion 51, an inner portion 51a disposed inside is formed in an oval shape having a wide width in the left-right direction so as to surround the two communication holes 50. An outer portion 51b disposed outside surrounds the periphery of the inner portion 51a, and has a substantially rectangular shape such that a front region (a region on a front side of the communication hole 50) when inflation is completed is farther away from the inner portion 51a than a rear region. More specifically, in the outer portion 51b, a width dimension in the left-right direction is set to be slightly narrower than width dimensions of the rear portion 42b of the lower wall portion 42 of the upper inflatable portion 38 and the rear upper portion 25b of the circumferential wall portion 25 of the lower inflatable portion 24 in the left-right direction (refer to FIG. 8 and FIG. 9). That is, in the upper body protection portion 21 of the airbag 20 according to the embodiment, the upper inflatable portion 38 and the lower inflatable portion 24 are connected to each other in a wide range by coupling the rear portion 42b of the lower wall portion 42 and the rear upper portion 25b of the circumferential wall portion 25 through the sewn portion 51 over substantially the entire region in the left-right direction. In other words, in the upper body protection portion 21 according to the embodiment, the rear portion 42b of the lower wall portion 42 of the upper inflatable portion 38 and the rear upper portion 25b of the circumferential wall portion 25 of the lower inflatable portion 24 are integrally formed by sewing the front regions which are the circumferential edges of the communication holes 50 to each other. Then, the rear portion 42b and the rear upper portion 25b are disposed to be inclined rearward and upward with respect to the horizontal direction when inflation of the airbag 20 is completed in a state of being mounted on the vehicle (refer to FIG. 20).

In the upper body protection portion 21 of the airbag 20 according to the embodiment, an internal tether 55 that regulates an inflation completion shape of the upper inflatable portion and a straightening cloth 63 that can straighten the inflation gas G1 flowing into the upper inflatable portion 38 are disposed in the upper inflatable portion 38 (refer to FIG. 7).

Specifically, the internal tether 55 is disposed in the rear region 38b of the upper inflatable portion 38. In the embodiment, the internal tether 55 includes a left-right connection portion 56 that connects the left wall portion 43 and the right wall portion 44, and a front-rear connection portion 57 that connects the left-right connection portion 56 and the rear wall portion 40. The internal tether 55 has a substantially Y-shape that is flat when viewed from the up-down direction (refer to FIG. 5). The left-right connection portion 56 is formed of a band-shaped sheet body having flexibility. Both ends of the left-right connection portion 56 are coupled at positions which are located slightly behind the centers of the left wall portion 43 and the right wall portion 44 in the front-rear direction and around the centers in the up-down direction such that the width direction is substantially along the up-down direction. Then, the left-right connection portion 56 is bent and is disposed such that the center of the left-right connection portion 56 in the left-right direction is located slightly rearward when inflation of the upper inflatable portion 38 is completed. In the embodiment, the left-right connection portion 56 is formed by arranging two tether base materials 59 and 59 illustrated in FIG. 14 side by side in the left-right direction (refer to FIG. 5). The front-rear connection portion 57 is disposed so as to connect the center of the left-right connection portion 56 in the left-right direction and substantially the center of the rear wall portion 40 in the up-down direction and the left-right direction. The front-rear connection portion 57 is formed of a band-shaped sheet body having flexibility. The front-rear connection portion 57 is disposed substantially along the front-rear direction when inflation of the upper inflatable portion 38 is completed such that the width direction is substantially along the up-down direction. In the embodiment, the front-rear connection portion 57 is formed such that a rear end side connected to the rear side is slightly wider than a front end side connected to the left-right connection portion 56 (refer to FIG. 7). When the airbag 20 is unfolded and is inflated, the internal tethers 55 prevent the left wall portion 43 and the right wall portion 44 of the upper inflatable portion 38 from protruding excessively outward in the left-right direction, and prevent the rear wall portion 40 from protruding excessively rearward. In addition, the internal tether 55 is disposed to regulate a separation distance between the left wall portion 43 and the right wall portion 44 of the airbag 20 when inflation is completed, and regulate excessive rearward protrusion of the rear wall portion 40 (regulate a separation distance between the left-right connection portion 56 and the rear wall portion 40).

The straightening cloth 63 is disposed so as to cover the periphery (specifically, above communication hole 50) of the communication hole 50 in the upper inflatable portion 38 (refer to FIG. 7 and FIG. 8). The straightening cloth 63 is formed to straighten the inflation gas G1 flowing into the straightening cloth through the communication hole 50. Specifically, the straightening cloth 63 is formed to straighten the inflation gas G1 flowing from the communication hole 50 outward in the left-right direction and forward. The straightening cloth 63 covers an upper side of the communication hole 50 by respectively sewing a front edge 63a side and a rear edge 63b side to the rear portion 42b of the lower wall portion 42 of the upper inflatable portion 38 in front of and behind the communication hole 50. Openings 65 and 65 for gas outflow are respectively disposed on the left end 63c side and the right end 63d side of the straightening cloth 63. In addition, in the straightening cloth 63, a gas outflow hole 66 which allows the inflation gas G1 to flow out is disposed in a front region 63e disposed on the front side. In the embodiment, one gas outflow hole 66 is disposed to be opened in a circular shape at the center of the front region 63e (to be described later) that forms the straightening cloth 63 (refer to FIG. 15). In the embodiment, as illustrated in FIG. 15, the straightening cloth 63 includes a front member 68 and a rear member 69. Outer shapes of the front member 68 and the rear member 69 are set to be substantially the same. The front member 68 and the rear member 69 form the straightening cloth 63 by sewing upper edges 68a and 69a to each other and respectively sewing lower edges 68b and 69b to the rear portion 42b of the lower wall portion 42. The upper edges 68a and 69a of the front member 68 and the rear member 69 are curved in an arc shape such that the centers of the front member 68 and the rear member 69 protrude upward.

Further, in the upper body protection portion 21 of the airbag 20 according to the embodiment, a separation distance D1 (refer to FIG. 4) between the front end (the inflow openings 28L and 28R) of the lower inflatable portion 24 and the front portion 42a of the lower wall portion 42 of the upper inflatable portion 38 in a state where the airbag is inflated alone when viewed from the left-right direction is set to be shorter than a separation distance D2 (refer to FIG. 2) between the inflow opening (that is, the front end of the case 16) of the airbag 20 and the front portion (that is, the upper surface 2 of the instrument panel 1) of the lower wall portion 42 of the upper inflatable portion 38 in a state where the airbag is mounted on the vehicle when viewed from the left-right direction.

In the embodiment, the knee protection portion 72 includes a protection main body portion 73 that inflates to protrude downward from the upper body protection portion 21, and a gas passage portion 85 that allows the inflation gas G2 to flow into the protection main body portion 73. As described above, the knee protection portion 72 is connected to the lower inflatable portion 24 by the lower regulating tethers 97L and 97R.

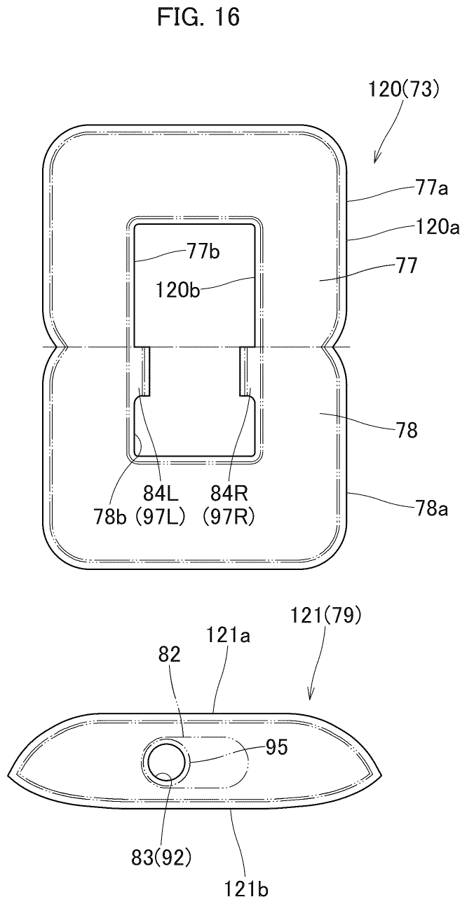

In the embodiment, the protection main body portion 73 is unfolded so as to protrude downward from the case 16 when the airbag 20 is unfolded and inflated. The protection main body portion 73 is formed to cover the front of the left and right knees K of the occupant MP when inflation is completed. Specifically, an outer shape of the protection main body portion 73 is a substantially U-shaped plate shape that is positioned from a lower region of the upper body protection portion 21 (the lower inflatable portion 24) to side regions of the lower inflatable portion 24 in the left-right direction in a state where the airbag 20 is viewed from the rear side when inflation is completed (refer to FIG. 4 to FIG. 7). That is, the protection main body portion 73 is disposed in a region from the lower side of the case 16 to the side regions in the left-right direction of the case 16 when inflation of the airbag 20 is completed. The protection main body portion 73 includes a central portion 74, a left portion 75L, and a right portion 75R. The central portion 74 is a portion that is disposed below the lower inflatable portion 24 when inflation is completed. The left portion 75L and the right portion 75R are portions that are respectively disposed along the up-down direction on the left side and the right side of the lower inflatable portion 24 when inflation is completed. The protection main body portion 73 is disposed substantially along the rear surface 3 of the instrument panel 1 when the airbag 20 is completely inflated. When inflation of the airbag 20 is completed, upper ends 75a of the left portion 75L and the right portion 75R are disposed at positions substantially coinciding with the upper surface of the lower inflatable portion 24 (refer to FIG. 20). In addition, the protection main body portion 73 includes a front wall portion 77 disposed on the instrument panel 1 side when inflation is completed, a rear wall portion 78 disposed on the occupant MP side, and a connection wall portion 79 connected to the upper body protection portion 21 (specifically, the lower inflatable portion 24) (refer to FIG. 10). The connection wall portion 79 forms a region on the upper end side of the protection main body portion 73 when inflation is completed. Outer shapes of the front wall portion 77 and the rear wall portion 78 are substantially the same U-shape (refer to FIG. 16). The connection wall portion 79 forms a portion from an upper surface of the central portion 74 to inner side surfaces of the left portion 75L and the right portion 75R (refer to FIG. 10 and FIG. 11). The connection wall portion 79 has an elongated shape along the left-right direction (refer to FIG. 16). The protection main body portion 73 has a bag shape by coupling outer edges 77a and 78a of the front wall portion 77 and the rear wall portion 78 to each other (outer edges 120a of a main body panel 120 (to be described later)) and coupling inner edges 77b and 78b of the front wall portion 77 and the rear wall portion 78 to a front edge 79a and a rear edge 79b of the connection wall portion 79 (an inner edge 120b of the main body panel 120 and a front edge 121a and a rear edge 121b of a connection wall panel 121 (to be described later)).

A region in the periphery of the center of the connection wall portion 79 (a region on the upper surface side of the central portion 74) is sewn to the front lower portion 25c of the circumferential wall portion 25 of the lower inflatable portion 24 using a suture thread. In this manner, the protection main body portion 73 is connected to the lower inflatable portion 24. A sewing portion 82 connecting the protection main body portion 73 and the lower inflatable portion 24 (the connection wall portion 79 and the front lower portion 25c) is formed in a substantially oval shape extending in the left-right direction. The sewing portion 82 is formed in the front lower portion 25c so as to surround the entire periphery of the opening 30 formed corresponding to the outflow hole 92 (refer to FIG. 11, FIG. 12, FIG. 15, and FIG. 16). The sewing portion 82 is disposed over substantially the entire region of the front lower portion 25c in the left-right direction (refer to FIG. 11 and FIG. 15). In a region of the connection wall portion 79 that is surrounded by the sewing portion 82, an opening 83 that forms the outflow hole 92 is formed corresponding to the opening 30 (refer to FIG. 12 and FIG. 16). On the inner edge 75b side in the left portion 75L and the right portion 75R of the protection main body portion 73, connection pieces 84L and 84R that form the lower regulating tethers 97L and 97R are formed (refer to FIG. 16). The connection pieces 84L and 84R are formed corresponding to the connection pieces 35L and 35R formed in the lower inflatable portion 24. The connection pieces 84L and 84R are formed at positions on the inner edge 75b side (specifically, the inner edge 78b in the periphery of the upper end of the rear wall portion 78) in the peripheries of the upper ends 75a of the left portion 75L and the right portion 75R. In the embodiment, the connection pieces 84L and 84R are formed on an inner edge 120b side of a region that forms the rear wall portion 78 in the main body panel 120 (refer to FIG. 16). The main body panel 120 forms a region of the front wall portion 77 and the rear wall portion 78 in the protection main body portion 73 of the knee protection portion 72.

The gas passage portion 85 is disposed in the lower inflatable portion 24 of the upper body protection portion 21 so as to connect the inflow opening 28R and the protection main body portion 73. The gas passage portion 85 has a substantially cylindrical shape extending rearward from the circumferential edge of the inflow opening 28R so as to cover the inflow opening 28R. The outflow hole 92 which allows the inflation gas G2 to flow out to the protection main body portion 73 is disposed on a leading end side of the gas passage portion 85 (refer to FIG. 10 to FIG. 12). Specifically, the gas passage portion 85 includes an upper wall portion 86 and a lower wall portion 87 which are disposed to face each other in the up-down direction when inflation of the airbag 20 is completed (refer to FIG. 10 and FIG. 12). The upper wall portion 86 and the lower wall portion 87 have the same outer shape and an oval shape extending in the front-rear direction (refer to FIG. 15). Then, the gas passage portion 85 is formed in a tubular shape by coupling outer circumferential edges of the upper wall portion 86 and the lower wall portion 87 over the entire circumference. Openings 88 and 89 are formed on a front end side of the lower wall portion 87 in correspondence with the inflow opening 28L and the attachment hole 29L, and the outflow hole 92 is formed to be opened in a circular shape on a rear end side of the lower wall portion 87 (refer to FIG. 10 and FIG. 15). As described below, the gas passage portion 85 is attached to an inner circumferential surface side of the lower inflatable portion 24, and is connected to the protection main body portion 73 such that the inflow opening 28L and the protection main body portion 73 communicate (connect) with each other. A circumferential edge of the opening 88 of the lower wall portion 87 is sewn (coupled) to a circumferential edge of the inflow opening 28L of the circumferential wall portion 25 of the lower inflatable portion 24 so as to form a sewing portion 94. A circumferential edge of the outflow hole 92 is sewn (coupled) to the circumferential edges of the opening 83 formed in the connection wall portion 79 and the opening 30 formed in the front lower portion 25c of the circumferential wall portion 25 of the lower inflatable portion 24 so as to form a sewing portion 95.

As described above, the lower regulating tethers 97L and 97R that connect the lower inflatable portion 24 of the upper body protection portion 21 and the knee protection portion 72 include the connection pieces 35L and 35R extending from the lower inflatable portion 24 and the connection pieces 84L and 84R extending from the knee protection portion 72 (refer to FIG. 13). Specifically, the lower regulating tethers 97L and 97R are formed by sewing (coupling) leading ends of the connection pieces 35L and 35R and the connection pieces 84L and 84R to each other. Specifically, the connection pieces 35L and 35R formed on the lower inflatable portion 24 side extend from an upper left edge side and an upper right edge side (the upper edge 26a side of the left wall portion 26 and the upper edge 27a side of the right wall portion 27) of the lower inflatable portion 24. The connection pieces 84L and 84R formed on the knee protection portion 72 side extend from the inner edge 75b sides (specifically, the inner edge 78b side of the rear wall portion 78) at positions in the peripheries of the upper ends 75a of the left portion 75L and the right portion 75R of the protection main body portion 73. That is, in the embodiment, the lower regulating tethers 97L and 97R connect the upper left edge side or the upper right edge side (the upper edge 26a side of the left wall portion 26 or the upper edge 27a side of the right wall portion 27) of the lower inflatable portion 24 and the inner rear edge sides in the peripheries of the upper ends 75a of the left portion 75L or the right portion 75R when inflation of the airbag 20 is completed.

In the airbag 20 according to the embodiment, the upper inflatable portion 38 and the lower inflatable portion 24 of the upper body protection portion 21, and the protection main body portion 73 of the knee protection portion 72 are formed in a bag shape by coupling circumferential edges of base materials (base cloth) having a predetermined shape to each other. The upper inflatable portion 38 includes one upper circumferential wall panel 100 and a pair of left and right upper wall panels 106L and 106R (refer to FIG. 14). The lower inflatable portion 24 includes one lower circumferential wall panel 110 and a pair of left and right lower wall panels 116L and 116R (refer to FIG. 15). The protection main body portion 73 includes a main body panel 120 and a connection wall panel 121 (refer to FIG. 16). In addition, as illustrated in FIG. 15, the gas passage portion 85 of the knee protection portion 72 includes one passage panel 125.

The upper circumferential wall panel 100 forms a region including the upper wall portion 41, the rear wall portion 40, the lower wall portion 42, and the front wall portion 39 in the upper inflatable portion 38. As illustrated in FIG. 14, the upper circumferential wall panel 100 has a substantially band shape of which the outer shape is substantially symmetrical in the left-right direction. On both end sides of the upper circumferential wall panel 100, lower rear formation portions 102A and 102B that form a rear portion 42b (a circumferential edge portion of the communication hole 50) of the lower wall portion 42 are disposed. In the upper circumferential wall panel 100, a narrow portion 103 that forms a portion from the front portion 42a of the lower wall portion 42 to the front side of the upper wall portion 41 through the front wall portion 39 and a wide portion 104 that forms a region from the rear side of the upper wall portion 41 to the rear wall portion 40 are disposed in series between the lower rear formation portions 102A and 102B.

The pair of left and right upper wall panels 106L and 106R forms a left wall portion 43 and a right wall portion 44 in the upper inflatable portion 38 that face each other in the left-right direction when inflation is completed, and has a symmetrical outer shape in the left-right direction (refer to FIG. 14). In the outer circumferential edges 107L and 107R of the upper wall panels 106L and 106R, the lower front portion 107a that forms the left edge or the right edge of the front portion 42a of the lower wall portion 42 and the lower rear portion 107b that forms the left edge or the right edge of the rear portion 42b of the lower wall portion 42 are formed so as to be substantially parallel to each other while being provided with a step.

The upper inflatable portion 38 has a bag shape as described below. In the upper circumferential wall panel 100, the lower rear formation portions 102A and 102B overlap each other such that front and rear end edges 100a and 100b are respectively sewn. The left edge 100c and the right edge 100d of the upper circumferential wall panel 100 are respectively sewn to the outer circumferential edges 107L and 107R of the upper wall panels 106L and 106R.

The lower circumferential wall panel 110 forms a circumferential wall portion 25 of the lower inflatable portion 24, and as illustrated in FIG. 15, has an outer shape which is substantially band shape and is substantially symmetrical in the left-right direction. On both end sides of the lower circumferential wall panel 110, front end formation portions 112A and 112B that form regions (circumferential portions of the inflow openings 28L and 28R) on the front end side of the circumferential wall portion 25 are disposed. In the lower circumferential wall panel 110, a rear upper surface formation portion 113 that forms a rear upper portion 25b (a circumferential edge portion of the communication hole 50) of the circumferential wall portion 25 and a lower surface formation portion 114 that forms a region from the rear end side to the lower surface side of the circumferential wall portion 25 are disposed in series between the front end formation portions 112A and 112B. The lower surface formation portion 114 is formed such that an intermediate portion in the front-rear direction have a narrow width.

The pair of left and right lower wall panels 116L and 116R forms a left wall portion 26 and a right wall portion 27 in the lower inflatable portion 24 that face each other in the left-right direction when inflation is completed, and has a symmetrical outer shape in the left-right direction (refer to FIG. 15). The connection pieces 35L and 35R that form the lower regulating tethers 97L and 97R are respectively disposed in the lower wall panels 116L and 116R. In the outer circumferential edges 117L and 117R of the lower wall panels 116L and 116R, front upper portion 117a and rear upper portion 117b are disposed so as to intersect each other at an obtuse angle. The front upper portion 117a is a portion that forms an upper edge of the front region 24a (a left edge or a right edge of the front upper portion 25a of the circumferential wall portion 25). The rear upper portion 117b is a portion that forms an upper edge of the rear region 24b (a left edge or a right edge of the rear upper portion 25b of the circumferential wall portion 25). In addition, the front upper portion 117a is slightly inclined rearward and upward with respect to the front lower portion 117c. The front lower portion 117c is a portion that forms a lower edge of the front region 24a. That is, the rear upper portions 117b of the outer circumferential edges 117L and 117R are inclined rearward and upward with respect to the front upper portions 117a. The rear lower portions 117d of the outer circumferential edges 117L and 117R of the lower wall panels 116L and 116R are disposed so as to be curved and downwardly inflated with respect to the rear upper portion 117b formed in a substantially linear shape. The rear lower portion 117d is a portion that forms a lower edge of the rear region 24b.

The lower inflatable portion 24 has a bag shape as described below. In the lower circumferential wall panel 110, the front end formation portions 112A and 112B overlap each other such that the front and rear end edges 110a and 110b are respectively sewn. The left edge 110c and the right edge 110d of the lower circumferential wall panel 110 are respectively sewn to the outer circumferential edges 117L and 117R of the lower wall panels 116L and 116R.

The main body panel 120 forms a region of the front wall portion 77 and the rear wall portion 78 in the protection main body portion 73 of the knee protection portion 72. As illustrated in FIG. 16, the main body panel 120 has a substantially quadrangular annular shape in which the front wall portion 77 and the rear wall portion 78 are connected to each other on the upper end side. The connection pieces 84L and 84R that form the lower regulating tethers 97L and 97R are disposed on the inner edge 120b side of the region that forms the rear wall portion 78 of the main body panel 120. The connection wall panel 121 forms a region of the connection wall portion 79 of the protection main body portion 73. The connection wall panel 121 has a substantially band shape with a wide width in the left-right direction. Specifically, as illustrated in FIG. 16, in the connection wall panel 121, the width dimension of the central portion that forms the upper surface side of the central portion 74 is constant. The width dimensions of the region on the left end side and the region on the right end side of the connection wall panel 121 are gradually reduced toward the end edge. The protection main body portion 73 of the knee protection portion 72 has a bag shape as described below. The main body panel 120 is folded in half, and the outer edges 120a are sewn to each other. The inner edge 120b of the main body panel 120 is sewn to each of the front edge 121a and the rear edge 121b of the connection wall panel 121. The passage portion panel 125 that forms the gas passage portion 85 of the knee protection portion 72 has a shape in which the upper wall portion 86 and the lower wall portion 87 are disposed side by side in the left-right direction (refer to FIG. 15). The gas passage portion 85 is formed into a bag shape by folding the passage portion panel 125 in half and coupling the corresponding outer circumferential edges 125a to each other.

In the embodiment, as illustrated in FIG. 14 to FIG. 16, the upper circumferential wall panel 100, the upper wall panels 106L and 106R, the lower circumferential wall panel 110, the lower wall panels 116L and 116R, the main body panel 120, the connection wall panel 121, and the passage portion panel 125, which are included in the airbag 20, the left-right connection portion 56 (tether base materials 59 and 59) and the front-rear connection portion 57, which are included in the internal tether 55, and the front member 68 and the rear member 69, which are included in the straightening cloth 63, are each formed of a flexible woven fabric made of a polyester yarn, a polyamide yarn, or the like.

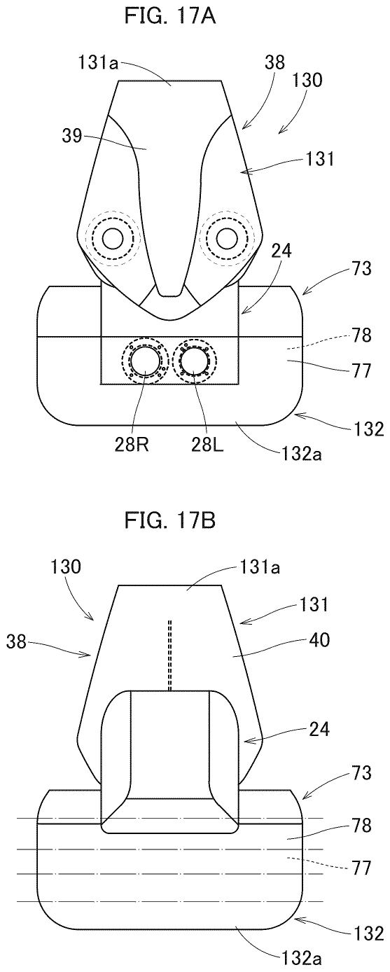

Next, mounting of the airbag device M according to the embodiment onto a vehicle will be described. First, the airbag 20 is folded so as to be storable in the case 16 in a state where the retainers 13L and 13R are stored in the airbag 20. The airbag 20 is folded such that the width dimension in the front-rear (up-down) direction and the left-right direction can be reduced from a state of a pre-folded bag 130 as illustrated in FIG. 17A and FIG. 17B. As illustrated in FIG. 17A and FIG. 17B, the pre-folded bag 130 is in a state where the upper inflatable portion 38 and the lower inflatable portion 24 of the upper body protection portion 21 and the protection main body portion 73 of the knee protection portion 72 overlap each other while being flatly unfolded. Specifically, in the pre-folded bag 130, the upper inflatable portion 38 forms the upper portion 131 in a state of being folded with folds in the regions of the upper wall portion 41, the lower wall portion 42, the left wall portion 43, and the right wall portion 44 such that the rear wall portion 40 is flatly unfolded over substantially the entire region and overlaps the front wall portion 49. The protection main body portion 73 of the knee protection portion 72 forms the lower portion 132 such that the front wall portion 77 and the rear wall portion 78 are overlapped in a state of being substantially flat unfolded. The lower inflatable portion 24 is disposed so as to be folded in half in the front-rear direction such that the front region is overlapped on the front wall portion 77 of the protection main body portion 73 and the rear region is overlapped on the rear wall portion 78 of the protection main body portion 73.

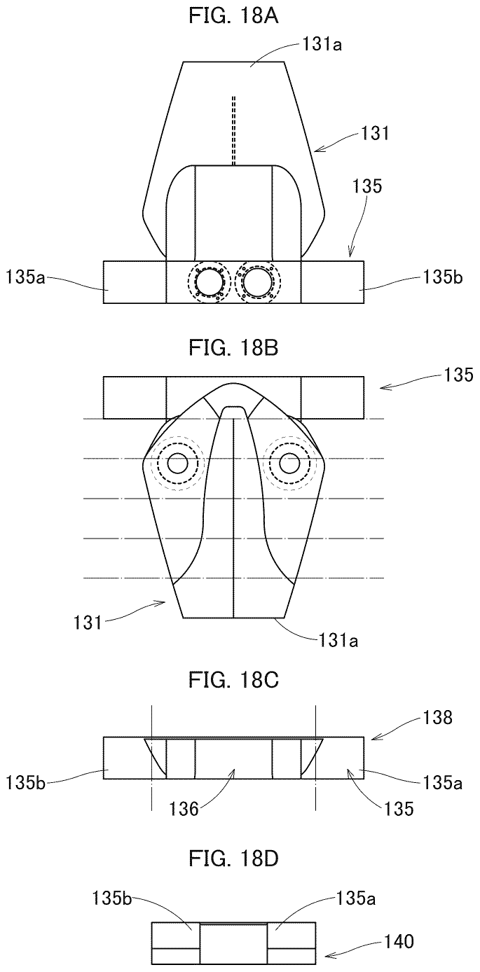

Then, in the pre-folded bag 130, first, a lower roll folded portion 135 is formed by winding the lower portion 132 from the lower edge 132a side toward the front wall portion 77 side. The lower roll folded portion 135 is overlapped on the inflow openings 28L and 28R (refer to FIG. 17B and FIG. 18A). At this time, the protection main body portion 73 and a part of the lower inflatable portion 24 of the upper body protection portion 21 are folded together. Next, an upper roll folded portion 136 is formed by winding the upper portion 131 from the upper edge 131a side toward the front wall portion 39 side. The upper roll folded portion 136 is overlapped on the lower roll folded portion 135 to form a folded bag 138 that is reduced in the up-down direction (refer to FIG. 18B and FIG. 18C). In the folded bag 138 that is reduced in the up-down direction, a left end 135a side and a right end 135b side of the lower roll folded portion 135 are folded to overlap with the upper roll folded portion 136. In this manner, the upper body protection portion 21 and the knee protection portion 72 (the protection main body portion 73) are integrally folded. Then, folding of the airbag 20 is completed, and thus, a folded body 140 can be formed (refer to FIG. 18C and FIG. 18D).

The periphery of the folded body 140 formed in this manner is wrapped with a tearable wrapping sheet (not illustrated) that prevents the folded body from being collapsed. Then, the folded body 140 is stored in the case 16 such that each bolt 13a protrudes from the bottom wall portion 16a. Next, the main body portion 12a of each of the inflators 12L and 12R is inserted into the case 16 from below the bottom wall portion 16a (the front side when being mounted on the vehicle). At the same time, the bolts 13a of the retainers 13L and 13R protruding from the bottom wall portion 16a are respectively inserted into the flange portions 12c of the inflators 12L and 12R. Thereafter, the nut 14 is fastened to each bolt 13a protruding from the flange portion 12c of each of the inflators 12L and 12R. Then, the folded airbag 20 and the inflators 12L and 12R can be attached to the case 16.

Thereafter, the circumferential wall portion 16b of the case 16 is engaged to the connection wall portion 10b of the airbag cover 10 in the instrument panel 1 mounted on the vehicle. A bracket (not illustrated) provided on the case 16 is fixed to the body side of the vehicle. The airbag device M can be mounted on the vehicle by electrically connecting the inflators 12L and 12R to an airbag operation circuit (not illustrated).

In the airbag device M according to the embodiment, after the airbag device M is mounted on the vehicle, when the inflation gas is discharged from the gas discharge port 12b of each of the inflators 12L and 12R, the inflation gas flows into the inside of the airbag 20, and thus, the airbag 20 is inflated. The airbag 20 pushes the door portion 10a of the airbag cover 10, and thus the door portion 10a is opened. Then, the airbag 20 protrudes rearward from the case 16 through the protruding opening 17 of the case 16 that is formed for pushing and opening the door portion 10a of the airbag cover 10. Thereafter, the airbag 20 is unfolded and is inflated in the up-down direction to complete inflation as illustrated by a two-dot chain line of FIG. 1 and FIG. 19. Specifically, in the airbag device M according to the embodiment, the inflators 12L and 12R are formed to operate at substantially the same time, and the knee protection portion 72 completes inflation prior to the upper body protection portion 21.

Then, in the airbag device M according to the embodiment, the airbag 20 is configured to inflate so as to cover the front of the occupant MP from the knees K to the upper body MU, but the upper body protection portion 21 configured to protect the upper body MU and the knee protection portion 72 configured to protect the knees K are respectively formed in a shape of a separate bag, and are respectively connected to the separate inflators 12L and 12R. Then, in the airbag device M according to the embodiment, in the airbag 20 when inflation is completed, for example, when the knee protection portion 72 (the protection main body portion 73) receives the knee K prior to a contact between the upper body MU and the upper body protection portion 21 (the upper inflatable portion 38), it is possible to prevent movement of the inflation gas from the knee protection portion 72 toward the upper body protection portion 21 side. Therefore, it is possible to secure an appropriate internal pressure of the knee protection portion 72, and it is possible to accurately protect the knee K by the knee protection portion 72. In addition, in the airbag device M according to the embodiment, the upper body protection portion 21 and the knee protection portion 72 are configured to be connected to the separate inflators 12L and 12R, but are disposed in the case 16 as one storage portion in a folded state. Therefore, a mounting space can be reduced as compared with a case where an airbag device for knee protection and an airbag device for upper body protection are respectively mounted as separate bodies on the vehicle. In addition, as compared with a case where an airbag device for knee protection and an airbag device for upper body protection are separately provided, the number of components and assembly steps can be reduced, and an increase in manufacturing cost can also be prevented.

Therefore, in the airbag device M according to the embodiment, even in a case where the upper body MU and the knee K are received by the airbag 20 when inflation is completed, the occupant MP can be accurately protected.

Further, in the airbag device M according to the embodiment, the upper body protection portion 21 and the knee protection portions 72 are integrally folded and are stored in the case 16. Therefore, as compared with the case where the upper body protection portion and the knee protection portion are separately folded and are stored in the storage portion (case), the folding work and the storage work in the storage portion can be smoothly performed.

Furthermore, in the airbag device M according to the embodiment, the knee protection portion 72 (protection main body portion 73) is configured to allow the inflation gas to flow into the inside of knee protection portion 72 through the gas passage portion 85 disposed so as to pass through the inside of the upper body protection portion 21 (the lower inflatable portion 24) when inflation is completed. The gas passage portion 85 disposed in the upper body protection portion 21 (the lower inflatable portion 24) is inflated by the inflation gas G2 discharged from the inflator 12L for the knee protection portion. In other words, the upper body protection portion 21 is set to have a decreased volume by the amount of the gas passage portion 85. Therefore, in the airbag device M according to the embodiment, the upper body protection portion 21 can be rapidly inflated by the decrease in volume. In addition, by inflating the knee protection portion 72 (the protection main body portion 73) via the gas passage portion 85 passing through the upper body protection portion 21, it is possible to prevent the protection main body portion 73 (the knee protection portion 72) and the upper body protection portion 21 (the lower inflatable portion 24) from being brought into pressure contact with each other in the case 16 or in a portion in the periphery of the case 16 when inflation is completed. Therefore, the disposition positions of the protection main body portion 73 (the knee protection portion 72) and the upper body protection portion 21 (the lower inflatable portion 24) can be stabilized. In a case where such a point is not taken into consideration, a knee protection portion that is configured to be directly connected to the inflator outside the upper body protection portion may be used without providing a gas passage portion passing through the inside of the upper body protection portion.

Further, in the airbag device according to the embodiment, the case 16 as a storage portion is disposed on the lower portion 1a side of the instrument panel 1 in front of the passenger seat. The upper body protection portion 21 is configured to inflate to be unfolded forward and upward while protruding rearward from the case 16. Then, the upper body protection portion 21 includes, as separate bags, the lower inflatable portion 24 that is connected to the inflator 12R and is inflated so as to protrude rearward from the case 16, and the upper inflatable portion 38 that communicates with the lower inflatable portion 24 via the communication hole 50 and is inflated on the upper side of the lower inflatable portion 24. The lower inflatable portion 24 and the upper inflatable portion 38 are connected to each other by being coupled at a portion of the circumferential edge of the communication hole 50. Therefore, in the airbag device M according to the embodiment, at the initial stage of the inflation of the airbag 20, in the upper body protection portion 21, first, the lower inflatable portion 24 allows the inflation gas G1 discharged from the inflator 12R to flow into the lower inflatable portion 24, and inflates so as to protrude rearward from the case 16. Thereafter, the upper inflatable portion 38 allows the inflation gas G1 to flow into the upper inflatable portion 38 through the communication hole 50, and inflates. Therefore, even in a case where the upper body protection portion 21 is inflated to be unfolded forward and upward while protruding rearward from the case 16, it is possible to prevent the upper inflatable portion 38 that actually receives the upper body MU of the occupant MP from being unfolded so as to excessively protrude toward the occupant MP side. As a result, the upper inflatable portion 38 can accurately protect the upper body MU of the occupant MP. In a case where such a point is not taken into consideration, the upper body protection portion may be formed integrally without being divided into the lower inflatable portion and the upper inflatable portion even if the upper body inflatable portion 38 is configured to protrude rearward from the storage portion.

In particular, in the airbag device M according to the embodiment, the upper inflatable portion 38 of the upper body protection portion 21 has the front lower surface side (the front portion 42a of the lower wall portion 42) in contact with the instrument panel 1 and the upper surface side (the upper wall portion 41) in contact with the front windshield 5 disposed above the instrument panel 1 when inflation is completed. A region on the rear lower surface side that forms the circumferential edge of the communication hole 50 in the upper inflatable portion 38 (the rear portion 42b of the lower wall portion 42) is supported by the lower inflatable portion 24. Then, in the lower inflatable portion 24, a region on the rear end side when inflation is completed (the rear region 24b) is thicker than a region on the front end side located on the case 16 side (the front region 24a). In addition, the upper surface of the lower inflatable portion 24 that supports the rear lower surface side of the upper inflatable portion 38 (the rear upper portion 25b of the circumferential wall portion 25) is inclined rearward and upward with respect to the horizontal direction in a state of being viewed from the left-right direction when inflation is completed. Therefore, when the upper inflatable portion 38 inflates, the lower inflatable portion 24 pushes the upper inflatable portion 38 forward and upward. This is because a surface of the lower inflatable portion 24 on the upper inflatable portion 38 side where inflation is substantially completed (a region that forms the circumferential edge of the communication hole 50) is inclined rearward and upward. As a result, the upper inflatable portion 38 that inflates can quickly come into contact with the front windshield 5 and the upper surface 2 of the instrument panel 1. In addition, also when inflation of the airbag 20 is completed, due to the inclination of the upper surface of the lower inflatable portion 24, a force acts on the upper inflatable portion 38 when inflation is completed so as to incline the entire upper inflatable portion 38 frontward and downward (to incline the front end 38aa downward). Thus, the upper inflatable portion 38 is pressed against the upper surface 2 of the instrument panel 1 over the region on the front end 38aa side when inflation is completed. This is because the lower inflatable portion 24 that supports the rear lower surface side of the upper inflatable portion 38 has the upper surface which is in contact with the upper inflatable portion 38 and this upper surface is inclined rearward and upward with respect to the horizontal direction. Therefore, the front lower surface of the upper inflatable portion 38 can be stably brought into contact with the upper surface 2 of the instrument panel 1 over the entire region in the front-rear direction.

Further, in the airbag device M according to the embodiment, the lower inflatable portion 24 is formed of a bag body separate from the upper inflatable portion 38. Therefore, when inflation is completed, it is possible to support the upper inflatable portion 38 by bringing the circumferential regions of the communication holes 50 into contact with each other. Then, in the lower inflatable portion 24, a region on the rear end side when inflation is completed (the rear region 24b) is thicker than a region on the front end side (the front region 24a). Therefore, the rear lower surface side of the upper inflatable portion 38 can be stably supported by the rear region 24b that inflates to be thick, and it is also possible to prevent the upper inflatable portion 38 from being moved and collapsed rearward and downward before the occupant is received. That is, in the airbag device M according to the embodiment, even in a case where the airbag 20 is stored on the lower portion 1a side of the instrument panel 1 and the upper body protection portion 21 is inflated so as to be unfolded forward and upward while protruding rearward, the upper inflatable portion 38 of the upper body protection portion 21 can be quickly inflated so as to abut against the upper surface 2 of the instrument panel 1 and the front windshield 5. In addition, when inflation of the upper inflatable portion 38 is completed, the contact state with the upper surface 2 of the instrument panel 1 can be stably maintained, and it is possible to prevent the upper inflatable portion 38 from being moved and collapsed rearward and downward after inflation is completed. As a result, the upper inflatable portion 38 supported by the upper surface 2 of the instrument panel 1, the front windshield 5, and the lower inflatable portion 24 can stably protect the upper body MU of the occupant MP.

Further, in the upper body protection portion 21 of the airbag 20 according to the embodiment, a separation distance D1 (refer to FIG. 4) between the front end (the inflow openings 28L and 28R) of the lower inflatable portion 24 and the front portion 42a of the lower wall portion 42 of the upper inflatable portion 38 in a state where the airbag is inflated alone when viewed from the left-right direction is set to be shorter than a separation distance D2 (refer to FIG. 2) between the inflow openings 28L and 28R (that is, the front end of the case 16) of the airbag 20 and the front portion 42a (that is, the upper surface 2 of the instrument panel 1) of the lower wall portion 42 of the upper inflatable portion 38 in a state where the airbag is mounted on the vehicle when viewed from the left-right direction. That is, in the embodiment, in a state of being mounted on the vehicle, the airbag 20 is inflated so as to expand a gap between the lower inflatable portion 24 and the upper inflatable portion 38. Then, the upper inflatable portion 38 completes inflation by strongly pressing (strongly interfering) the front lower surface side (the front portion 42a of the lower wall portion 42) against the upper surface 2 of the instrument panel 1. Therefore, when inflation of the upper inflatable portion 38 is completed, the contact state with the upper surface 2 of the instrument panel 1 can be stably maintained.

In addition, in the airbag device M according to the embodiment, in the knee protection portion 72, the peripheries of the upper ends 75a of the left portion 75L and the right portion 75R, which are disposed on the sides of the lower inflatable portion 24 in the left-right direction, and the left edge side and the right edge side (the left wall portion 26 side and the right wall portion 27 side) of the lower inflatable portion 24 are respectively configured to be connected by the lower regulating tethers 97L and 97R. Therefore, it is possible to prevent occurrence of a gap between the sides of the lower inflatable portion 24 in the left-right direction and the left portion 75L or the right portion 75R of the knee protection portion 72 when inflation of the airbag 20 is completed. As a result, when inflation of the airbag 20 is completed, in a case where the knee protection portion 72 receives the knees K of the occupant MP, the knees K of the occupant MP can be prevented from entering a gap between the left portion 75L or the right portion 75R and the lower inflatable portion 24. Then, the left portion 75L and the right portion 75R can accurately restrain the knees K of the occupant MP.

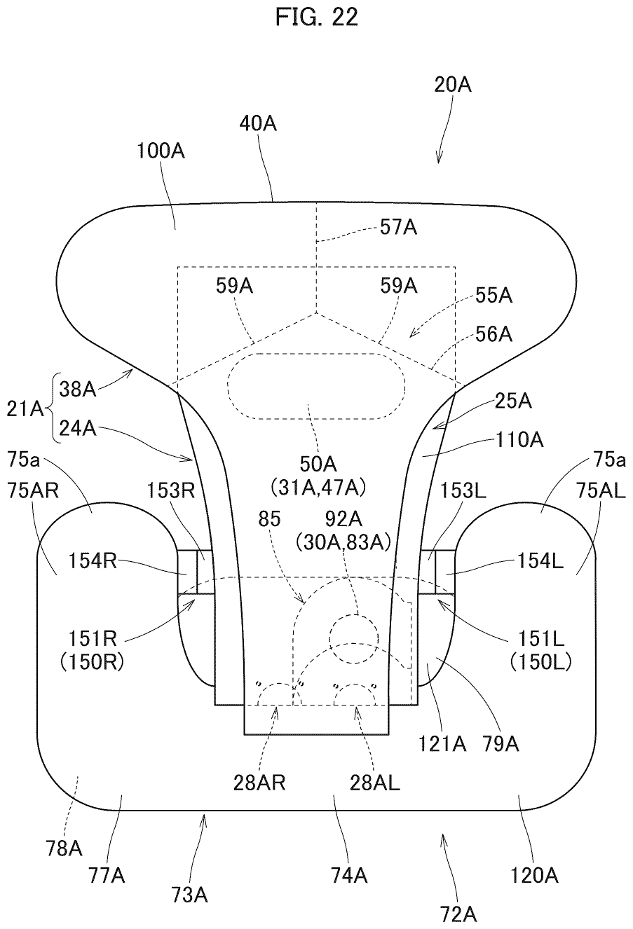

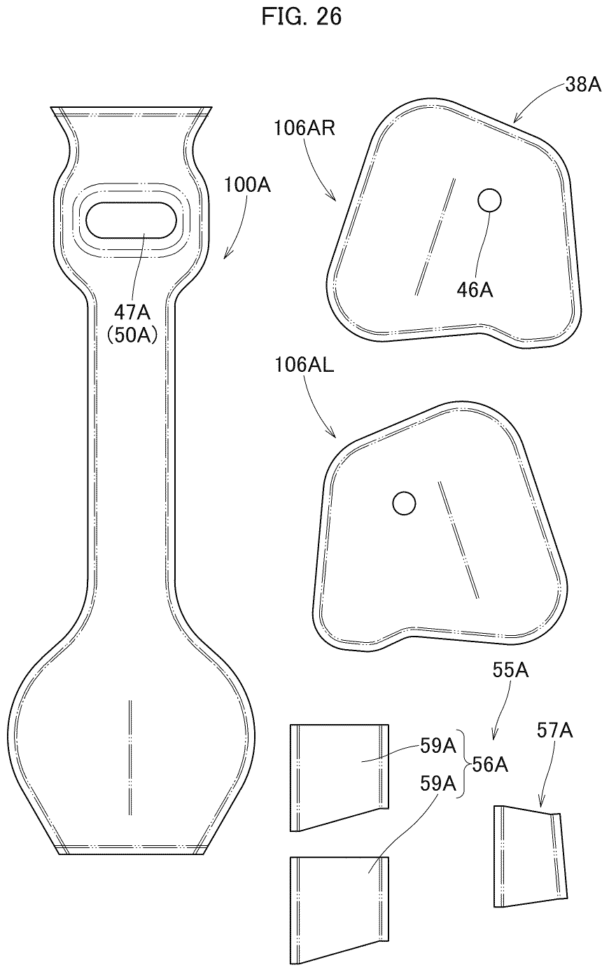

Further, as the airbag 20A, an airbag having a configuration illustrated in FIG. 22 can also be used. As illustrated in FIG. 22 to FIG. 28, the airbag 20A has the same configuration as the airbag 20 described above, except for the lower regulating tethers 150L and 150R that connect the knee protection portion 72A and the lower inflatable portion 24A of the upper body protection portion 21A, although the shape is slightly different. Therefore, the members other than the lower regulating tethers 150L and 150R are designated by the same reference numerals with “A” added to the end, and detailed description thereof will be omitted.

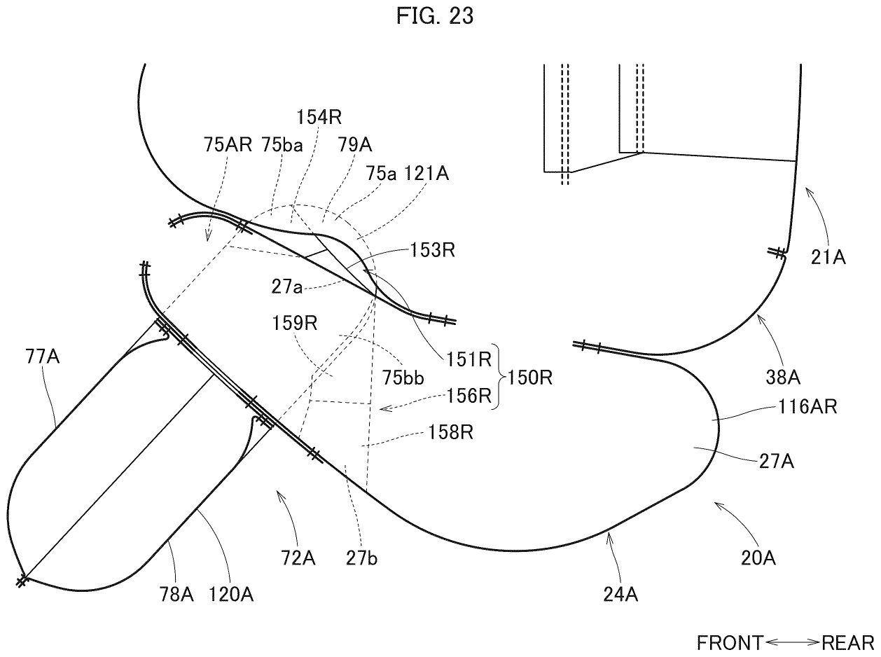

In the airbag 20A, the lower regulating tethers 150L and 150R that connect the knee protection portion 72A and the lower inflatable portion 24A of the upper body protection portion 21A include front portions 151L and 151R that are disposed on the front side which is the instrument panel side and rear portions 156L and 156R that are disposed on the rear side which is the occupant side when inflation of the airbag 20A is completed (refer to FIG. 23).

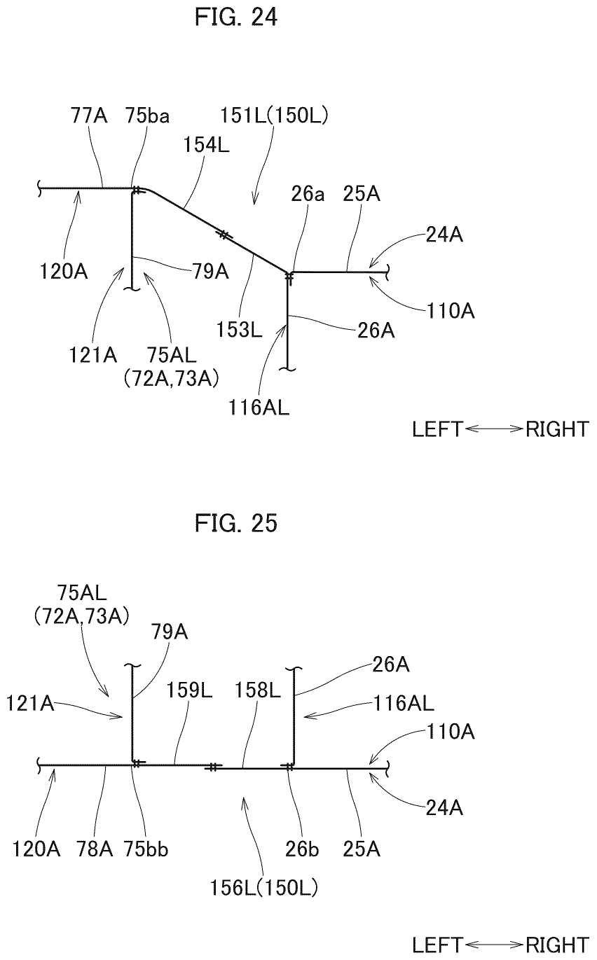

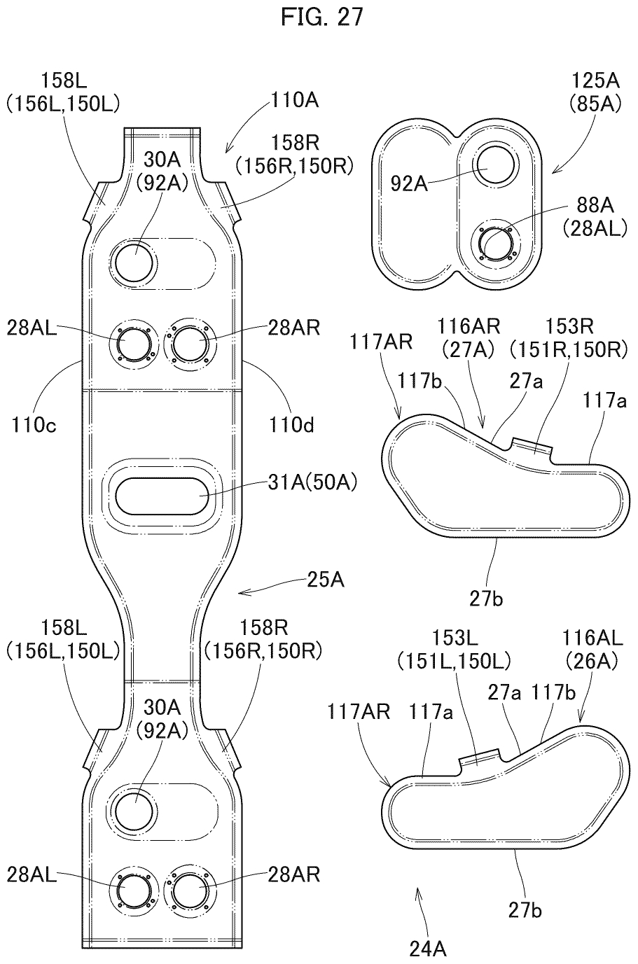

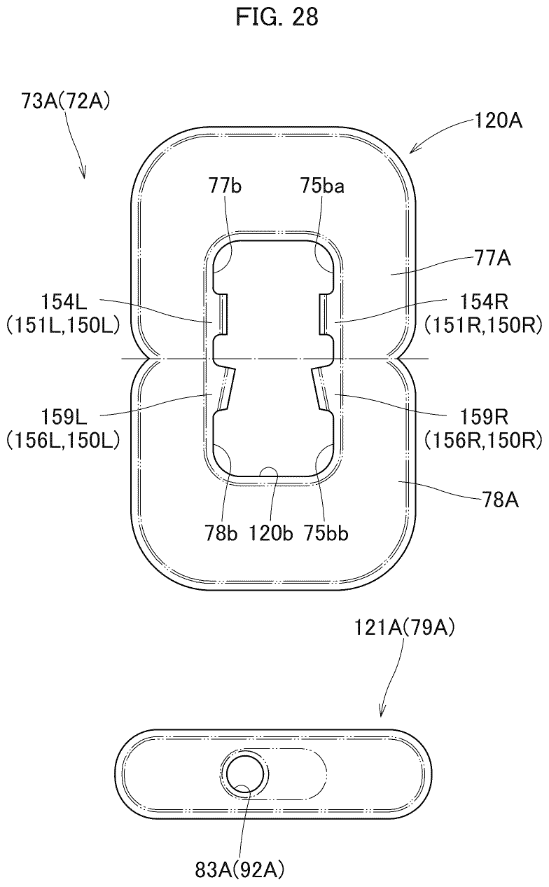

The front portions 151L and 151R include front inner connection pieces 153L and 153R and front outer connection pieces 154L and 154R (refer to FIG. 23 and FIG. 24). The front inner connection pieces 153L and 153R are formed to extend from the lower inflatable portion 24A. The front outer connection pieces 154L and 154R are formed to extend from the knee protection portion 72A. Specifically, the front inner connection pieces 153L and 153R formed on the lower inflatable portion 24A side extend from an upper left edge side and an upper right edge side (the upper edge 26a side of the left wall portion 26A and the upper edge 27a side of the right wall portion 27A) of the lower inflatable portion 24A (refer to FIG. 23 and FIG. 24). Specifically, the front inner connection pieces 153L and 153R protrude from the periphery of a boundary portion between the front upper portion 117a and the rear upper portion 117b of the outer circumferential edges 117AL and 117AR of the lower wall panels 116AL and 116AR (to be described later) (refer to FIG. 27). The lower wall panels 116AL and 116AR form a left wall portion 26A and a right wall portion 27A. The front outer connection pieces 154L and 154R formed on the knee protection portion 72A side extend from the inner front edge 75ba side (specifically, the inner edge 77b side of the front wall portion 77A) at positions in the peripheries of the upper ends 75a of the left portion 75AL and the right portion 75AR of the protection main body portion 73A. Specifically, the front outer connection pieces 154L and 154R are formed on an inner edge 120b side of a region that forms the front wall portion 77A in the main body panel 120A (refer to FIG. 28). The main body panel 120A forms a region of the front wall portion 77A and the rear wall portion 78A in the protection main body portion 73A of the knee protection portion 72A. Then, the front portions 151L and 151R are formed by sewing (coupling) the leading ends of the front inner connection pieces 153L and 153R and the front outer connection pieces 154L and 154R to each other (refer to FIG. 23 and FIG. 24).

The rear portions 156L and 156R include rear inner connection pieces 158L and 158R and rear outer connection pieces 159L and 159R (refer to FIG. 23 and FIG. 24). The rear inner connection pieces 158L and 158R are formed to extend from the lower inflatable portion 24A. The rear outer connection pieces 159L and 159R are formed to extend from the knee protection portion 72A. Specifically, the rear inner connection pieces 158L and 158R formed on the lower inflatable portion 24A side extend from a lower left edge side and a lower right edge side (the lower edge 26b side of the left wall portion 26A and the lower edge 27b side of the right wall portion 27A) of the lower inflatable portion 24A (refer to FIG. 23 and FIG. 24). Specifically, the rear inner connection pieces 158L and 158R protrude from a region, which is located on the lower surface side of the circumferential wall portion 25A when inflation is completed, in the left edge 110c and the right edge 110d of the lower circumferential wall panel 110A (refer to FIG. 27). The lower circumferential wall panel 110A forms a circumferential wall portion 25A of the lower inflatable portion 24A. The rear outer connection pieces 159L and 159R formed on the knee protection portion 72A side extend from the inner rear edge 75bb side (specifically, the inner edge 78b side of the rear wall portion 78A) at positions in the peripheries of the upper ends 75a of the left portion 75AL and the right portion 75AR of the protection main body portion 73A. Specifically, the rear outer connection pieces 159L and 159R are formed on an inner edge 120b side of a region that forms the rear wall portion 78A in the main body panel 120A (refer to FIG. 28). The main body panel 120A forms a region of the front wall portion 77A and the rear wall portion 78A in the protection main body portion 73A of the knee protection portion 72A. Then, the rear portions 156L and 156R are formed by sewing (coupling) the leading ends of the rear inner connection pieces 158L and 158R and the rear outer connection pieces 159L and 159R to each other (refer to FIG. 23 and FIG. 24).

When inflation of the airbag 20A is completed, the front portions 151L and 151R and the rear portions 156L and 156R in the lower regulating tethers 150L and 150R are disposed so as to respectively connect the knee protection portion 72A and the lower inflatable portion 24A of the upper body protection portion 21A at positions separated in the front-rear direction. Specifically, the front portions 151L and 151R are disposed on the front side (instrument panel side) by connecting the upper left edge side or the upper right edge side (the upper edge 26a side of the left wall portion 26A or the upper edge 27a side of the right wall portion 27A) of the lower inflatable portion 24A and the inner front edge 75ba side of the left portion 75AL or the right portion 75AR of the knee protection portion 72A. The rear portions 156L and 156R are disposed on the rear side (occupant side) by connecting the lower left edge side or the lower right edge side (the lower edge 26b side of the left wall portion 26A or the lower edge 27b side of the right wall portion 27A) of the lower inflatable portion 24A and the inner rear edge 75bb side of the left portion 75AL or the right portion 75AR of the knee protection portion 72A (refer to FIG. 23). In practice, as illustrated in FIG. 23, the front portion 151R (151L) is disposed above and in front of the rear portion 156R (156L) in a twisted manner.

Then, in a case where the airbag 20A having such a configuration is used, the lower regulating tethers 150L and 150R connect the left side surface or the right side surface of the lower inflatable portion 24A and the inner side surface of each of the left portion 75AL and the right portion 75AR of the knee protection portion 72A to each other at two positions separated in the front-rear direction. Therefore, the knee protection portion 72A can be stably inflated by the lower regulating tethers 150L and 150R when the airbag 20A is unfolded and is inflated. Specifically, the front portions 151L and 151R connect the inner front edge 75ba side at the upper end 75a side of each of the left portion 75AL and the right portion 75AR of the knee protection portion 72A to the upper left edge side or the upper right edge side (the upper edge 26a side of the left wall portion 26A or the upper edge 27a side of the right wall portion 27A) of the lower inflatable portion 24A. Therefore, in the initial stage of inflation of the airbag 20A, the knee protection portion 72A protruding from the case (not illustrated) can be prevented from being inflated to collapse the upper end 75a side of each of the left portion 75AL and the right portion 75AR toward the occupant while separating from the lower inflatable portion 24A. In addition, the rear portions 156L and 156R connect the inner rear edge 75bb side at the upper end 75a side of each of the left portion 75AL and the right portion 75AR of the knee protection portion 72A to the lower left edge side or the lower right edge side (the lower edge 26b side of the left wall portion 26A or the lower edge 27b side of the right wall portion 27A) of the lower inflatable portion 24A. Therefore, in the initial stage of inflation of the airbag 20A, it is also possible to prevent the upper end 75a side of each of the left portion 75AL and the right portion 75AR from being inflated so as to protrude outward in the left-right direction while separating from the lower inflatable portion 24A. As a result, in the airbag device using the airbag 20A having such a configuration, the lower regulating tethers 150L and 150R can stabilize the positions of the left portion 75AL and the right portion 75AR of the knee protection portion 72A (prevent shaking in the left-right direction when the airbag is unfolded). Then, the knee protection portion 72A can be quickly inflated so as to widely and accurately cover the front of the left and right knees of the occupant. Then, the knee protection portion 72A (the left portion 75AL and the right portion 75AR) can more accurately restrain the knees of the occupant.

The airbag device M according to the embodiment is configured to operate the two inflators 12L and 12R substantially at the same time. However, the operation timings of the two inflators may be appropriately different as necessary. Further, in the embodiment, the two inflators 12L and 12R are disposed side by side in the left-right direction and are attached to the bottom wall portion 16a of the case 16. However, the disposition of the two inflators is not limited to the embodiment. The two inflators may be disposed side by side in the up-down direction, or may be disposed side by side in an oblique direction.

Further, in the embodiment, an airbag device for a passenger seat for protecting an occupant seated on the passenger seat has been described as an example. The airbag device to which the present invention can be applied is not limited to the airbag device for a passenger seat. The present invention is also applicable to an airbag device disposed in front of a driver's seat or in front of a rear seat.

The present invention relates to an airbag device having the following configuration.

An airbag device according to the present invention is disposed in front of an occupant seated on a seat, the airbag device including:
an airbag that is folded and is stored in a storage portion and inflates so as to cover a front portion from knees to an upper body of the occupant,
wherein
the airbag includes an upper body protection portion configured to protect the upper body and a knee protection portion configured to protect the knees, and
each of the upper body protection portion and the knee protection portion is formed in a shape of a separate bag, is connected to a separate inflator, is configured to allow an inflation gas to flow into the upper body protection portion or the knee protection portion, and is folded and is stored in the storage portion.

In the airbag device according to the present invention, the airbag is configured to inflate so as to cover the front of the occupant from the knees to the upper body, but the upper body protection portion configured to protect the upper body and the knee protection portion configured to protect the knees are formed in a shape of a separate bag, and are connected to the separate inflators. Then, in the airbag device according to the present invention, in the airbag when inflation is completed, for example, when the knee protection portion receives the knee prior to a contact between the upper body and the upper body protection portion, it is possible to prevent movement of the inflation gas from the knee protection portion toward the upper body protection portion. Therefore, it is possible to secure an appropriate internal pressure of the knee protection portion, and it is possible to accurately protect the knee by the knee protection portion. In addition, in the airbag device according to the present invention, the upper body protection portion and the knee protection portion are connected to the separate inflators, but are disposed in one storage portion in a folded state. Therefore, a mounting space can be reduced as compared with a case where an airbag device for knee protection and an airbag device for upper body protection are respectively mounted as separate bodies on the vehicle. In addition, as compared with a case where an airbag device for knee protection and an airbag device for upper body protection are separately provided, the number of components and assembly steps can be reduced, and an increase in manufacturing cost can also be prevented.

Therefore, in the airbag device according to the present invention, even in a case where the upper body and the knee are received by the airbag when inflation is completed, the occupant can be accurately protected.

Further, in the airbag device according to the present invention, preferably, the upper body protection portion and the knee protection portion are integrally folded and are stored in the storage portion. With this configuration, as compared with the case where the upper body protection portion and the knee protection portion are separately folded and are stored in the storage portion, the folding work and the storage work in the storage portion can be smoothly performed.

In the airbag device according to the present invention, preferably, the knee protection portion is configured to allow an inflation gas to flow into the inside of the knee protection portion via a gas passage portion disposed to pass through the inside of the upper body protection portion when inflation is completed.

In the airbag device having such a configuration, the gas passage portion disposed in the upper body protection portion is inflated by the inflation gas discharged from the inflator for the knee protection portion. In other words, the upper body protection portion is set to have a decreased volume by the amount of the gas passage portion. Therefore, the upper body protection portion can be rapidly inflated by the decrease in volume. In addition, by inflating the knee protection portion via the gas passage portion passing through the upper body protection portion, it is possible to prevent the knee protection portion and the upper body protection portion from being brought into pressure contact with each other in the storage portion or in a portion in the periphery of the storage portion when inflation is completed. Therefore, the disposition positions of the knee protection portion and the upper body protection portion can be stabilized.

Specifically, in the airbag device, preferably, the storage portion is disposed on a lower portion side of an instrument panel in front of a passenger seat, and the upper body protection portion is configured to: allow the inflation gas to flow into the inside, and inflate so as to be unfolded forward and upward while protruding rearward from the storage portion; and include a lower inflatable portion that is connected to the inflator and inflates so as to protrude rearward from the storage portion and an upper inflatable portion that communicates with the lower inflatable portion via a communication hole and inflates on an upper side of the lower inflatable portion, the lower inflatable portion and the upper inflatable portion being formed in a shape of a separate bag and being connected to each other by coupling the lower inflatable portion and the upper inflatable portion at a portion of a circumferential edge of the communication hole.

According to the airbag device with the configuration, at the initial stage of the inflation of the airbag, in the upper body protection portion, first, the lower inflatable portion allows the inflation gas discharged from the inflator to flow into the lower inflatable portion, and inflates so as to protrude rearward from the storage portion. Thereafter, the upper inflatable portion allows the inflation gas to flow into the upper inflatable portion through the communication hole, and inflates. Therefore, even in a case where the upper body protection portion is inflated to be unfolded forward and upward while protruding rearward from the storage portion, it is possible to prevent the upper inflatable portion that actually receives the upper body of the occupant from being unfolded so as to excessively protrude toward the occupant. As a result, the upper inflatable portion (the upper body protection portion) can accurately protect the upper body of the occupant.

Further, in the airbag device having the above configuration, preferably, the knee protection portion includes a left portion and a right portion that are disposed on left and right sides of the lower inflatable portion when inflation is completed, and a left edge side and a right edge side of the lower inflatable portion are respectively connected to peripheries of upper ends of the left portion and the right portion by lower regulating tethers.

According to the airbag device having the above configuration, by connecting the peripheries of the upper ends of the left portion and the right portion of the knee protection portion to the left edge side and the right edge side of the lower inflatable portion by the lower regulating tethers, it is possible to prevent occurrence of a gap between the left and right sides of the lower inflatable portion and the left portion and the right portion of the knee protection portion when inflation of the airbag is completed. Therefore, when inflation of the airbag is completed, in a case where the knee protection portion receives the knees of the occupant, the knees of the occupant can be prevented from entering a gap between the left portion and the right portion and the lower inflatable portion. As a result, the left portion and the right portion can accurately restrain the knees of the occupant.

In the airbag device having the configuration in which the lower regulating tethers are disposed, specifically, preferably, each of the lower regulating tethers is configured to include, when inflation of the airbag is completed:
a front portion that is disposed on a front side which is the instrument panel side by connecting an upper left edge side or an upper right edge side of the lower inflatable portion and an inner front edge side of the left portion or the right portion; and
a rear portion that is disposed on a rear side which is the occupant side by connecting a lower left edge side or a lower right edge side of the lower inflatable portion and an inner rear edge side of the left portion or the right portion.

According to the airbag device having the above configuration, the lower regulating tethers can connect the left side surface or the right side surface of the lower inflatable portion and the inner side surface of each of the left portion and the right portion to each other at two positions separated in the front-rear direction. Therefore, the knee protection portion can be stably inflated by the lower regulating tethers when the airbag is unfolded and is inflated. Specifically, the front portions connect the inner front edge side at the upper end side of each of the left portion and the right portion of the knee protection portion to the upper left edge side or the upper right edge side of the lower inflatable portion. Therefore, in the initial stage of inflation of the airbag, the knee protection portion protruding from the storage portion can be prevented from being inflated to collapse the upper ends of the left portion and the right portion toward the occupant while separating from the lower inflatable portion. Further, the rear portions connect the inner rear edge side at the upper end side of each of the left portion or the right portion of the knee protection portion to the lower left edge side or the lower right edge side of the lower inflatable portion. Therefore, in the initial stage of inflation of the airbag, it is also possible to prevent the upper end side of each of the left portion and the right portion from being inflated so as to protrude outward in the left-right direction and so as to be separated from the lower inflatable portion. As a result, in the airbag device having the above configuration, the lower regulating tethers can stabilize the positions of the left portion and the right portion of the knee protection portion (prevent shaking in the left-right direction when the airbag is unfolded). Then, the knee protection portion can be quickly inflated so as to widely and accurately cover the front of the left and right knees of the occupant. Then, the knee protection portion (the left portion and the right portion) can more accurately restrain the knees of the occupant.

What is claimed is:

1. An airbag device disposed in front of an occupant seated on a seat, the airbag device comprising:
an airbag that is folded and is stored in a storage portion and inflates so as to cover a front portion from knees to an upper body of the occupant, wherein
the airbag includes an upper body protection portion configured to protect the upper body and a knee protection portion configured to protect the knees, and
each of the upper body protection portion and the knee protection portion is formed in a shape of a separate bag, is connected to a separate inflator, is configured to allow an inflation gas to flow into the upper body protection portion or the knee protection portion, and is folded and is stored in the storage portion.

2. The airbag device according to claim 1, wherein
the upper body protection portion and the knee protection portion are integrally folded and are stored in the storage portion.

3. The airbag device according to claim 1, wherein
the knee protection portion is configured to allow an inflation gas to flow into the inside of the knee protection portion via a gas passage portion disposed to pass through the inside of the upper body protection portion when inflation is completed.

4. The airbag device according to claim 1, wherein
the storage portion is disposed on a lower portion side of an instrument panel in front of a passenger seat, and
the upper body protection portion is configured to:
allow the inflation gas to flow into the inside, and inflate so as to be unfolded forward and upward while protruding rearward from the storage portion; and
include a lower inflatable portion that is connected to the inflator and inflates so as to protrude rearward from the storage portion and an upper inflatable portion that communicates with the lower inflatable portion via a communication hole and inflates on an upper side of the lower inflatable portion, the lower inflatable portion and the upper inflatable portion being formed in a shape of a separate bag and being connected to each other by coupling the lower inflatable portion and the upper inflatable portion at a portion of a circumferential edge of the communication hole.

5. The airbag device according to claim 4, wherein
the knee protection portion includes a left portion and a right portion that are disposed on left and right sides of the lower inflatable portion when inflation is completed, and
a left edge side and a right edge side of the lower inflatable portion are respectively connected to peripheries of upper ends of the left portion and the right portion by lower regulating tethers.

6. The airbag device according to claim 5, wherein
each of the lower regulating tethers is configured to include, when inflation of the airbag is completed:
a front portion that is disposed on a front side which is the instrument panel side by connecting an upper left edge side or an upper right edge side of the lower inflatable portion and an inner front edge side of the left portion or the right portion; and
a rear portion that is disposed on a rear side which is the occupant side by connecting a lower left edge side or a lower right edge side of the lower inflatable portion and an inner rear edge side of the left portion or the right portion.

7. The airbag device according to claim 4, wherein
when inflation is completed, the upper inflatable portion has a front lower surface which is brought into contact with the instrument panel and an upper surface which is brought into contact with a front windshield disposed above the instrument panel, and a region on a rear lower surface side which forms a circumferential edge of the communication hole is supported by the lower inflatable portion, and
the lower inflatable portion is configured such that a region on a rear end side when inflation is completed is thicker than a region on a front end side which is located on the storage portion side, and an upper surface which supports a rear lower surface side of the upper inflatable portion is inclined rearward and upward with respect to a horizontal direction in a state of being viewed from a left-right direction when inflation is completed.
